(19) United States
(12) Patent Application Publication
(10) Pub. No.: US 2026/0304497 A1
(43) Pub. Date: Oct. 1, 2026

(54) ADAPTATION OF PHYSICAL RANDOM ACCESS CONTROL CHANNEL RESOURCES

(71) Applicant: QUALCOMM Incorporated, San Diego, CA (US)

(72) Inventors: Ahmed Attia ABOTABL, San Diego, CA (US); Hung Dinh LY, San Diego, CA (US); Jae Ho RYU, San Diego, CA (US)

(21) Appl. No.: 19/091,674

(22) Filed: Mar. 26, 2025

(51) Int. Cl. H04W 74/0838; H04W 72/23

(52) U.S. Cl. CPC H04W 74/0838; H04W 72/23

(57) ABSTRACT

This disclosure provides methods, components, devices and systems for adaptation of physical random access control channel (PRACH) resources. For example, the described techniques may enable a UE to determine which PRACH configuration and which additional random access channel occasions (ROs) may be activated. For example, a downlink control information (DCI) message activating a contention-based or contention free RACH procedure may include one or more bits indicating whether additional ROs defined with respect to dedicated ROs, common ROs, or both are activated. Additionally, or alternatively, the UE may determine a duration of one or more activated resources based on a type of activation message. For example, a paging DCI and a physical downlink control channel (PDCCH) order message may be associated with respective activation durations for additional ROs activated by the paging DCI or the PDCCH order message.

### INTRODUCTION

This disclosure relates generally to wireless communication, and more specifically to systems, devices, methods, and techniques associated with adaptation of physical random access control channel (PRACH) resources. Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a network entity is described. The method may include receiving first control information that configures a set of common random access channel occasions (ROs) for contention-based random access (CBRA), a set of dedicated ROs for contention free random access (CFRA), or both, receiving second control information that configures a first set of additional ROs associated with the CBRA, a second set of additional ROs associated with the CFRA, or both, receiving a PDCCH order that activates a CFRA procedure, where the PDCCH order is configured to activate the set of dedicated ROs, the first set of additional ROs, the second set of additional ROs, or any combination thereof based on satisfaction of one or more conditions, and transmitting a random access message via the set of dedicated ROs, the first set of additional ROs, or the second set of additional ROs in accordance with the PDCCH order.

A network entity for wireless communication is described. The network entity may include a processing system that includes processor circuitry and memory circuitry that stores code. The processing system may be configured to cause the network entity to receive first control information that configures a set of common ROs for CBRA, a set of dedicated ROs for CFRA, or both, receive second control information that configures a first set of additional ROs associated with the CBRA, a second set of additional ROs associated with the CFRA, or both, receive a PDCCH order that activates a CFRA procedure, where the PDCCH order is configured to activate the set of dedicated ROs, the first set of additional ROs, the second set of additional ROs, or any combination thereof based on satisfaction of one or more conditions, and transmit a random access message via the set of dedicated ROs, the first set of additional ROs, or the second set of additional ROs in accordance with the PDCCH order.

Another network entity for wireless communication is described. The network entity may include means for receiving first control information that configures a set of common ROs for CBRA, a set of dedicated ROs for CFRA, or both, means for receiving second control information that configures a first set of additional ROs associated with the CBRA, a second set of additional ROs associated with the CFRA, or both, means for receiving a PDCCH order that activates a CFRA procedure, where the PDCCH order is configured to activate the set of dedicated ROs, the first set of additional ROs, the second set of additional ROs, or any combination thereof based on satisfaction of one or more conditions, and means for transmitting a random access message via the set of dedicated ROs, the first set of additional ROs, or the second set of additional ROs in accordance with the PDCCH order.

A non-transitory computer-readable medium storing code for wireless communication is described. The code may include instructions executable by one or more processors to receive first control information that configures a set of common ROs for CBRA, a set of dedicated ROs for CFRA, or both, receive second control information that configures a first set of additional ROs associated with the CBRA, a second set of additional ROs associated with the CFRA, or both, receive a PDCCH order that activates a CFRA procedure, where the PDCCH order is configured to activate the set of dedicated ROs, the first set of additional ROs, the second set of additional ROs, or any combination thereof based on satisfaction of one or more conditions, and transmit a random access message via the set of dedicated ROs, the first set of additional ROs, or the second set of additional ROs in accordance with the PDCCH order.

In some examples of the method, network entities, and non-transitory computer-readable medium described herein, the PDCCH order may be configured to activate the first set of additional ROs associated with the CBRA procedure when the one or more conditions include that the first control information configures the set of common ROs for CBRA in an initial bandwidth part (BWP), the first control information configures the set of dedicated ROs for CFRA in the initial BWP, and the second control information configures the first set of additional ROs associated with the CBRA.

In some examples of the method, network entities, and non-transitory computer-readable medium described herein, the PDCCH order may be not configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the PDCCH order activates the CFRA procedure.

A method for wireless communication by a network entity is described. The method may include receiving first control information that configures a set of common ROs and a set of additional ROs, receiving second control information that triggers a random access procedure, where the second control information activates, for the random access procedure, the set of common ROs, the set of additional ROs, or both, and where a duration of activation is associated with a type of message that carries the second control information, and transmitting a random access message via the set of common ROs or the set of additional ROs in accordance with the second control information.

A network entity for wireless communication is described. The network entity may include a processing system that includes processor circuitry and memory circuitry that stores code. The processing system may be configured to cause the network entity to receive first control information that configures a set of common ROs and a set of additional ROs, receive second control information that triggers a random access procedure, where the second control information activates, for the random access procedure, the set of common ROs, the set of additional ROs, or both, and where a duration of activation is associated with a type of message that carries the second control information, and transmit a random access message via the set of common ROs or the set of additional ROs in accordance with the second control information.

Another network entity for wireless communication is described. The network entity may include means for receiving first control information that configures a set of common ROs and a set of additional ROs, means for receiving second control information that triggers a random access procedure, where the second control information activates, for the random access procedure, the set of common ROs, the set of additional ROs, or both, and where a duration of activation is associated with a type of message that carries the second control information, and means for transmitting a random access message via the set of common ROs or the set of additional ROs in accordance with the second control information.

A non-transitory computer-readable medium storing code for wireless communication is described. The code may include instructions executable by one or more processors to receive first control information that configures a set of common ROs and a set of additional ROs, receive second control information that triggers a random access procedure, where the second control information activates, for the random access procedure, the set of common ROs, the set of additional ROs, or both, and where a duration of activation is associated with a type of message that carries the second control information, and transmit a random access message via the set of common ROs or the set of additional ROs in accordance with the second control information.

In some examples of the method, network entities, and non-transitory computer-readable medium described herein, the duration of the activation includes a first duration when the type of message may be a paging DCI message or a second duration when the type of message may be a PDCCH order.

A method for wireless communication by a network entity is described. The method may include outputting first control information that configures a set of common ROs for CBRA, a set of dedicated ROs for CFRA, or both, outputting second control information that configures a first set of additional ROs associated with the CBRA, a second set of additional ROs associated with the CFRA, or both, outputting a PDCCH order that activates a CFRA procedure, where the PDCCH order is configured to activate the set of dedicated ROs, the first set of additional ROs, the second set of additional ROs, or any combination thereof based on satisfaction of one or more conditions, and monitoring for a random access message via the set of dedicated ROs, the first set of additional ROs, or the second set of additional ROs in accordance with the PDCCH order.

A network entity for wireless communication is described. The network entity may include a processing system that includes processor circuitry and memory circuitry that stores code. The processing system may be configured to cause the network entity to output first control information that configures a set of common ROs for CBRA, a set of dedicated ROs for CFRA, or both, output second control information that configures a first set of additional ROs associated with the CBRA, a second set of additional ROs associated with the CFRA, or both, output a PDCCH order that activates a CFRA procedure, where the PDCCH order is configured to activate the set of dedicated ROs, the first set of additional ROs, the second set of additional ROs, or any combination thereof based on satisfaction of one or more conditions, and monitor for a random access message via the set of dedicated ROs, the first set of additional ROs, or the second set of additional ROs in accordance with the PDCCH order.

Another network entity for wireless communication is described. The network entity may include means for outputting first control information that configures a set of common ROs for CBRA, a set of dedicated ROs for CFRA, or both, means for outputting second control information that configures a first set of additional ROs associated with the CBRA, a second set of additional ROs associated with the CFRA, or both, means for outputting a PDCCH order that activates a CFRA procedure, where the PDCCH order is configured to activate the set of dedicated ROs, the first set of additional ROs, the second set of additional ROs, or any combination thereof based on satisfaction of one or more conditions, and means for monitoring for a random access message via the set of dedicated ROs, the first set of additional ROs, or the second set of additional ROs in accordance with the PDCCH order.

A non-transitory computer-readable medium storing code for wireless communication is described. The code may include instructions executable by one or more processors to output first control information that configures a set of common ROs for CBRA, a set of dedicated ROs for CFRA, or both, output second control information that configures a first set of additional ROs associated with the CBRA, a second set of additional ROs associated with the CFRA, or both, output a PDCCH order that activates a CFRA procedure, where the PDCCH order is configured to activate the set of dedicated ROs, the first set of additional ROs, the second set of additional ROs, or any combination thereof based on satisfaction of one or more conditions, and monitor for a random access message via the set of dedicated ROs, the first set of additional ROs, or the second set of additional ROs in accordance with the PDCCH order.

In some examples of the method, network entities, and non-transitory computer-readable medium described herein, the PDCCH order may be configured to activate the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the second set of additional ROs associated with the CFRA, and the PDCCH order activates the CFRA procedure.

In some examples of the method, network entities, and non-transitory computer-readable medium described herein, the PDCCH order may be configured to activate the second set of additional ROs associated with the CFRA procedure when the one or more conditions include that the first control information configures the set of common ROs for CBRA in an initial BWP, the first control information configures the set of dedicated ROs for CFRA in an active BWP different from the initial BWP, the second control information configures the second set of additional ROs associated with the CFRA, and the PDCCH order activates the CFRA procedure.

In some examples of the method, network entities, and non-transitory computer-readable medium described herein, the PDCCH order may be configured to activate both of the first set of additional ROs associated with the CBRA procedure and the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

In some examples of the method, network entities, and non-transitory computer-readable medium described herein, the PDCCH order may be configured to activate one of the first set of additional ROs associated with the CBRA procedure or the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

A method for wireless communication by a network entity is described. The method may include outputting first control information that configures a set of common ROs and a set of additional ROs, outputting second control information that triggers a random access procedure, where the second control information activates, for the random access procedure, the set of common ROs, the set of additional ROs, or both, and where a duration of activation is associated with a type of message that carries the second control information, and monitoring for a random access message via the set of common ROs or the set of additional ROs in accordance with the second control information.

A network entity for wireless communication is described. The network entity may include a processing system that includes processor circuitry and memory circuitry that stores code. The processing system may be configured to cause the network entity to output first control information that configures a set of common ROs and a set of additional ROs, output second control information that triggers a random access procedure, where the second control information activates, for the random access procedure, the set of common ROs, the set of additional ROs, or both, and where a duration of activation is associated with a type of message that carries the second control information, and monitor for a random access message via the set of common ROs or the set of additional ROs in accordance with the second control information.

Another network entity for wireless communication is described. The network entity may include means for outputting first control information that configures a set of common ROs and a set of additional ROs, means for outputting second control information that triggers a random access procedure, where the second control information activates, for the random access procedure, the set of common ROs, the set of additional ROs, or both, and where a duration of activation is associated with a type of message that carries the second control information, and means for monitoring for a random access message via the set of common ROs or the set of additional ROs in accordance with the second control information.

A non-transitory computer-readable medium storing code for wireless communication is described. The code may include instructions executable by one or more processors to output first control information that configures a set of common ROs and a set of additional ROs, output second control information that triggers a random access procedure, where the second control information activates, for the random access procedure, the set of common ROs, the set of additional ROs, or both, and where a duration of activation is associated with a type of message that carries the second control information, and monitor for a random access message via the set of common ROs or the set of additional ROs in accordance with the second control information.

In some examples of the method, network entities, and non-transitory computer-readable medium described herein, the duration of the activation includes a first duration when the type of message may be a paging DCI message or a second duration when the type of message may be a PDCCH order.

### BRIEF DESCRIPTION OF THE DRAWINGS

FIG. 1 shows an example of a wireless communication system.

FIG. 2 shows an example of a signaling configuration that supports adaptation of physical random access control channel (PRACH) resources.

FIG. 3 shows an example of a resource diagram that supports adaptation of PRACH resources.

FIG. 4 shows an example of a resource diagram that supports adaptation of PRACH resources.

FIG. 5 shows an example of timing diagrams that support adaptation of PRACH resources.

FIG. 6 shows an example of a process flow that supports adaptation of PRACH resources.

FIG. 7 shows an example of a process flow that supports adaptation of PRACH resources.

FIG. 8 shows a block diagram of a processing system that supports adaptation of PRACH resources.

FIG. 9 shows a diagram of a system including a device that supports adaptation of PRACH resources.

FIG. 10 shows a block diagram of a processing system that supports adaptation of PRACH resources.

FIG. 11 shows a diagram of a system including a device that supports adaptation of PRACH resources.

FIGS. 12 through 15 show flowcharts illustrating methods that support adaptation of PRACH resources.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may perform a physical random access channel (PRACH) procedure to establish a connection with a network entity. In some examples, the UE may perform contention-based random access (CBRA) via one or more resources (e.g., RACH occasions (ROs)) that may be common across multiple UEs, or may perform contention free random access (CFRA) via one or more resources (e.g., ROs) that may be dedicated for the UE. In some examples, the UE may be configured with additional ROs for one or both of the dedicated ROs and the common ROs. Additionally, in some examples, the UE may receive a first type of message (e.g., a paging downlink control information (DCI)) to activate the CBRA configuration and a second type of message (e.g., a DCI message, a physical downlink control channel (PDCCH) order message) to activate the CFRA configuration. In such examples, if the UE performs a first type of PRACH procedure (e.g., CFRA or CBRA), the UE may not be aware of whether the UE may transmit over additional ROs configured for a second type of PRACH procedure, or a duration associated with activation of the additional ROs.

Aspects of the subject matter described in this disclosure relate to methods for a UE to determine which configuration and which additional ROs may be activated by a PDCCH order message. For example, the PDCCH order message may include one or more bits indicating whether additional ROs defined with respect to the dedicated ROs, the common ROs, or both are activated. In some examples, which additional ROs are activated may be based on whether the UE is indicated to perform CBRA or CFRA, or may be based on a bandwidth part (BWP) configured for the UE. Additionally, or alternatively, the UE may determine a duration of one or more activated resources based on a type of activation message. For example, the paging DCI and the PDCCH order message may be associated with respective activation durations for additional ROs activated by the paging DCI or the PDCCH order message.

Particular aspects of the subject matter described in this disclosure can be implemented to realize one or more of the following potential advantages. In some examples, by defining activation configurations for additional ROs, the described techniques can be used to improve coordination between devices. Additionally, by enabling dynamic activation of additional ROs, the described techniques may increase reliability in wireless communication systems by enabling relatively faster RACH procedures.

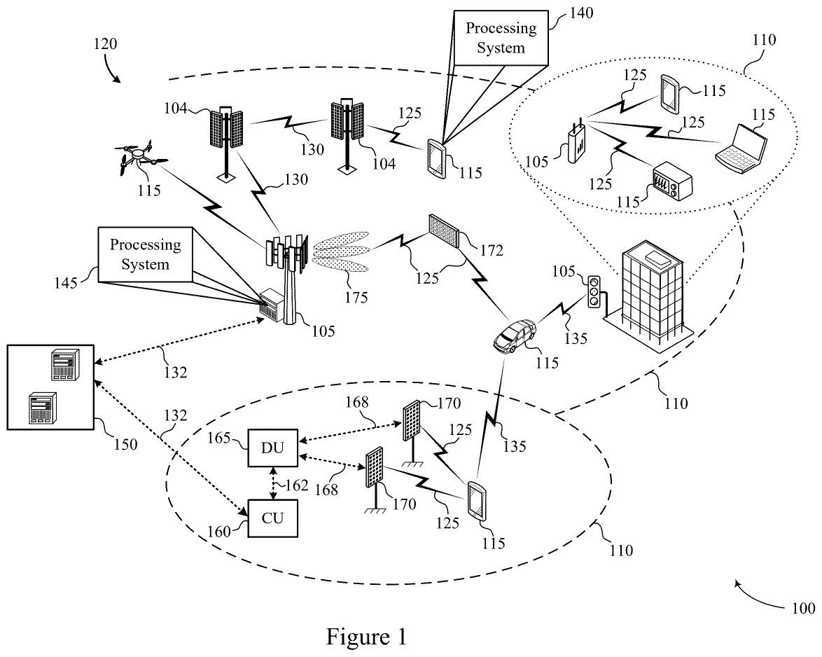

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 145. Similarly, the network entity (e.g., UE 115) may include a processing system 140. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

In some examples of the wireless communication system 100, a UE 115 may perform a RACH procedure (e.g., a contention free random access (CFRA) procedure or a contention based random access (CBRA) procedure) to establish a connection with a network entity 105. The UE 115 may receive a PDCCH order message (e.g., with DCI format 1_0 with a cell radio network temporary identifier (C-RNTI)) or a paging DCI requesting for the UE 115 to perform a random access procedure. The UE 115 may determine that the PDCCH message is a PDCCH order message if a frequency domain resource allocation (FDRA) field of the PDCCH message is set to all 1's.

The PDCCH order message may indicate a configuration for a first message (e.g., msg1, msgA) of the RACH procedure and information for the UE 115 to determine a RACH occasion for the first message. For example, the configuration may include six bits indicating a preamble index, one bit indicating for the UE 115 to transmit the first message via an uplink or supplementary uplink indicator, six bits indicating a synchronization signal block (SSB) index associated with the RACH occasion, and four bits indicating a physical PRACH (PRACH) mask index associated with the RACH occasion. The PDCCH order message may include a set of reserved bits (e.g., ten or twelve reserved bits).

If the PDCCH order message includes a non-zero preamble index, the PDCCH order message may trigger the UE 115 to perform CFRA. The UE 115 may accordingly transmit the first message based on the indicated configuration in the indicated RACH occasion. If the configuration includes a preamble index of 0, the PDCCH order message may trigger the UE 115 to perform CBRA. The UE 115 may accordingly ignore the remaining PDCCH order message fields and select (e.g., randomly select) a preamble for the first message. The UE 115 may determine a RACH occasion in which to transmit the first message based on a measured SSB. Accordingly, in a CBRA procedure, one or more UEs 115 may select a same RACH occasion and preamble, which may result in a collision at the network entity 105.

Devices of the wireless communication system 100 may be configured to support one or more aspects of the described techniques for adaptation of PRACH resources. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support enabling a UE 115 to determine which configuration and which additional ROs may be activated by a PDCCH order message. For example, the PDCCH order message may include one or more bits indicating whether additional ROs defined with respect to the dedicated ROs, the common ROs, or both are activated. In some examples, which additional ROs are activated may be based on whether the UE 115 is indicated to perform CBRA or CFRA, or may be based on a BWP configured for the UE. Additionally, or alternatively, the UE may determine a duration of one or more activated resources based on a type of activation message. For example, the paging DCI and the PDCCH order message may be associated with respective activation durations for additional ROs activated by the paging DCI or the PDCCH order message.

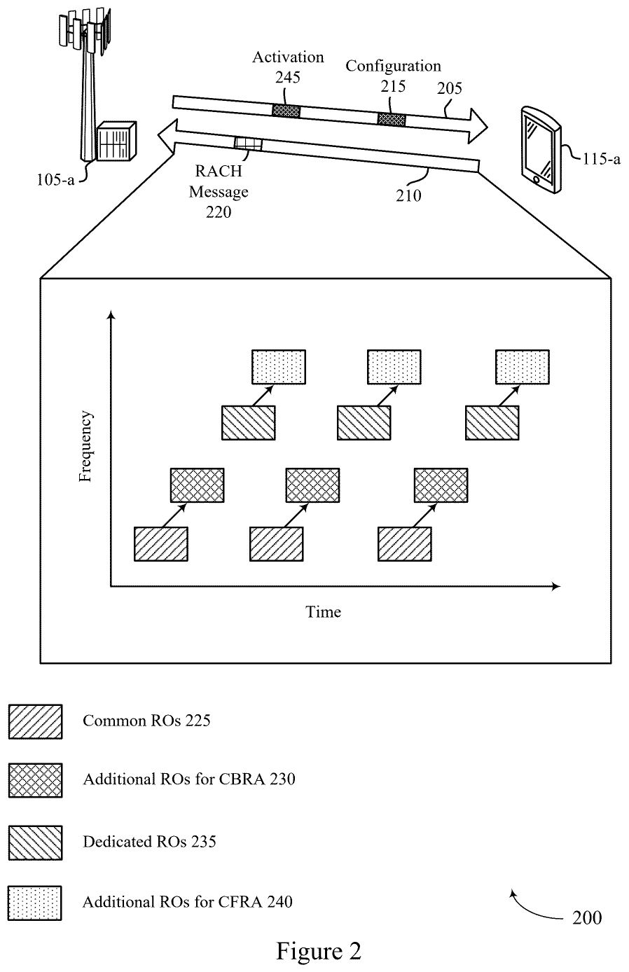

FIG. 2 shows an example of a signaling configuration 200 that supports adaptation of PRACH resources. The signaling configuration 200 may implement or may be implemented by aspects of the wireless communication system 100. For example, the signaling configuration 200 may be implemented by a UE 115 (e.g., a UE 115-a) or a network entity 105 (e.g., a network entity 105-a), which may be examples of the corresponding devices as described with reference to FIG. 1.

In some examples of the signaling configuration 200, a UE 115-a may perform a RACH procedure (e.g., a CBRA or CFRA) to establish communications with a network entity 105-a. As part of the RACH procedure, the UE 115-a may transmit one or more RACH messages 220 (e.g., a msgA of a two-step RACH procedure or a msg2 of a four-step RACH procedure) to the network entity 105-a via an uplink channel 210. The UE 115-a may transmit the RACH message 220 via one or more ROs, such as common ROs 225 for CBRA or dedicated ROs 235 for CFRA. The network entity 105-a may accordingly configure the UE 115-a with the ROs via a configuration 215 transmitted via a downlink channel 205. In some examples, the configuration 215 may include a configuration for CBRA (e.g., a common configuration for 2-step RACH or 4-step RACH, an additional configuration, a system information request configuration, a two timing alignment (two-TA) configuration) and/or a configuration for CFRA (e.g., a dedicated configuration for 2-step RACH or 4-step RACH, an additional configuration, a lower layer triggered mobility (LTM) configuration, a ReconfiguraitonWithSync, or a beam failure recovery (BFR) configuration).

In some examples, the UE 115-a may identify one or more triggering events that may trigger CBRA or CFRA. For example, triggering events for the CBRA procedure may include initial access to the network entity 105-a from an RRC Idle state (e.g., via an RRCSetupRequest in a msg3 of a four-step RACH procedure), transition from an RRC Inactive to an RRC Connected state (e.g., via an RRCSetupRequest in a msg3), RRC connection re-establishment (e.g., via an RRCReestablishmentRequest in a msg3), handover, downlink data arrival while the UE 115-a is out of sync, uplink data arrival while the UE 115-a is out of sync, uplink data arrival for the UE 115-a without a physical uplink shared channel (PUSCH) resource allocation, on-demand system information (e.g., via a msg3), beam failure recovery, scheduling request failure (e.g., if the network entity 105-a does not provide an uplink grant after a threshold quantity of scheduling request), synchronous reconfiguration or establishing time alignment during addition of a special cell (SCell). Triggering events for the CFRA procedure may include handover, downlink data arrival while the UE 115-a is out of sync, on-demand system information (e.g., via a msg1), beam failure recovery, synchronous reconfiguration, or establishing time alignment during addition of an SCell (e.g., to initialize Timing Advance for the SCell belonging to a new Timing Advance Group (TAG)). In some examples, for contention resolution, the UE 115-a may include a C-RNTI medium access control-control element (MAC-CE) in a msg3 and/or a buffer status report (BSR) MAC-CE to request additional uplink resources.

In some examples, the network entity 105-a may provide additional information for the UE 115-a to perform the RACH procedure (e.g., by providing a preamble using a RACH-ConfigDedicated in an RRCReconfiguration, by signaling a PDCCH-Order using a DCI format 1_0 with a preamble index for CFRA or without a preamble index for CBRA, based on including a si-RequestConfig in a system information block (SIB) for CFRA, by providing the UE 115-a with a PRACH preamble index for one or more beams available for recovery for CFRA, by including a parameter reconfigurationWithSync in an RRCReconfiguration). In some examples, whether a triggered RACH procedure is CFRA or CBRA may be based on whether the network entity 105-a provides a preamble. For example, for CFRA, the network entity 105-a may provide a RACH preamble for the UE 115-a to use. For CBRA, the network entity 105-a may not provide a RACH preamble for the UE 115-a to use for RACH, and the UE 115-a may select the RACH preamble (e.g., randomly select, select based on an SSB beam configured for recovery).

In some examples, to increase power savings at the network entity 105-a, the network entity 105-a may perform adaptation of one or more messages (e.g., synchronization signal blocks (SSBs), PRACH messages), which may enable the network entity 105-a to refrain from monitoring ROs when UEs 115 may not transmit RACH messages via the ROs. For example, the network entity 105-a may perform dynamic adaptation of PRACH resources (e.g., the additional ROs) in a time domain and/or in a spatial domain (e.g., with non-uniform PRACH resources per SSB). Additionally, the network entity 105-a may adapt paging occasions for paging messages (e.g., by confining the paging occasions in the time domain without increasing a latency of paging messages).

To support such PRACH adaptation, the UE 115-a may receive an activation 245 (e.g., via a PDCCH order or a paging DCI) that may indicate one or more of the configured additional ROs (e.g., additional ROs for CBRA 230 or additional ROs for CFRA 240) that are activated for PRACH. For example, an activation message such as a PDCCH order (e.g., with a DCI format 1_0 with a C-RNTI used to trigger PRACH, or one or more other DCI formats such as a format 2_7 or a format 2_9) may include one or more bits in one or more bit fields that indicate whether additional PRACH resources are available for a triggered PRACH procedure. In some examples, the activation message may be associated with an RNTI used for detecting the associated DCI format (e.g., P-RNTI, SI-RNTI, CellDTRX-RNTI, PEI-RNTI, C-RNTI, or another RNTI).

In some examples, the UE 115-a may be configured with both additional PRACH resources that may be dynamically adapted and other PRACH resources (e.g., common ROs 225 and dedicated ROs 235) that may not be dynamically adapted. In such examples, the configuration of the additional PRACH resources may be provided via semi-static signaling from the network entity 105-a. In some examples, the additional PRACH resources may overlap in time with the other PRACH resources (e.g., common ROs 225 and dedicated ROs 235).

In some examples, however, if both of the dedicated and common PRACH configurations exist (e.g., if the UE 115-a is configured with both common ROs 225 and dedicated ROs 235), the UE 115-a may be unaware of which additional ROs (e.g., the additional ROs for CBRA 230 or the additional ROs for CFRA 240) are defined and/or activated. That is, the UE 115-a may be unaware of which additional configuration (e.g., the additional ROs for CBRA 230 or the additional ROs for CFRA 240) may be activated by the activation 245 in the activation message (e.g., the PDCCH order). Additionally, if the UE 115-a is configured with additional ROs for CBRA 230 but not with additional ROs for CFRA 240, the UE 115-a may be unaware of whether the PDCCH order may activate the additional ROs for CBRA 230.

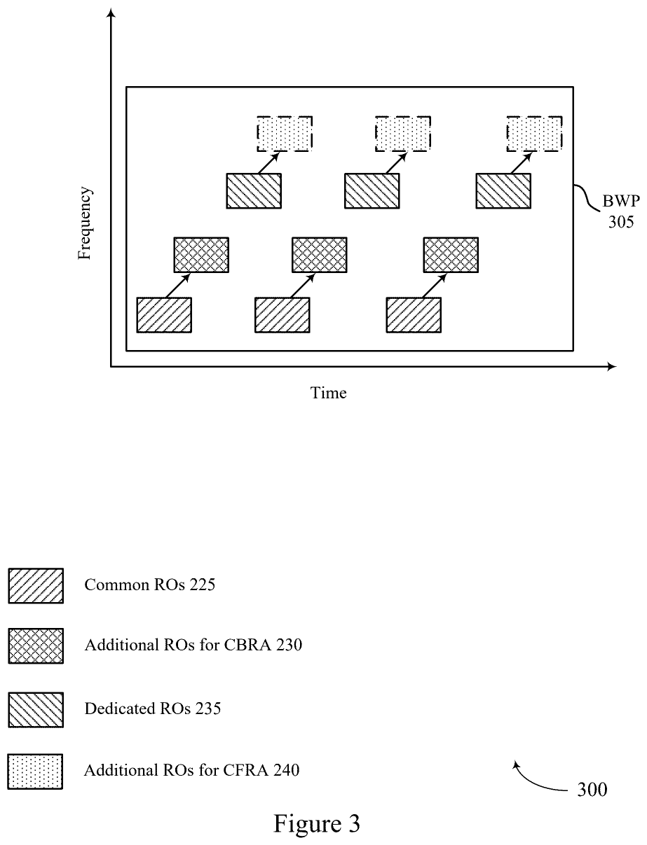

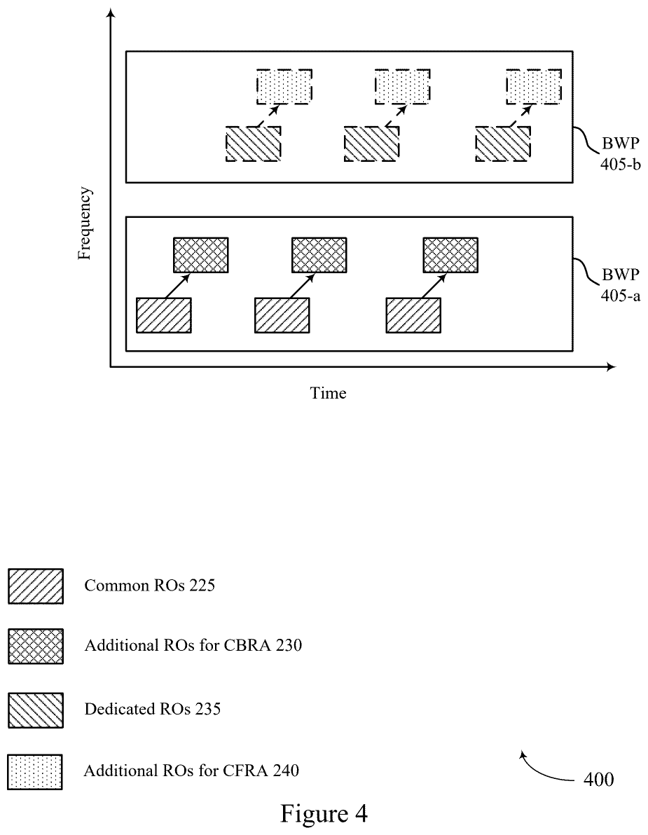

Accordingly, techniques described herein may enable the UE 115-a to identify one or more conditions for which ROs may be activated by the PDCCH order. In some examples, the conditions may include whether the UE 115-a is configured with the additional ROs for CBRA 230 or the additional ROs for CFRA 240. In some examples, the conditions may include whether the UE 115-a is indicated to perform CBRA or CFRA. In some examples, the conditions may include whether an initial BWP (e.g., a BWP in which the UE 115-a is configured with common ROs 225 and/or additional ROs for CBRA 230) is the same as an active BWP (e.g., a BWP in which the UE 115-a is configured with dedicated ROs 235 and/or additional ROs for CFRA 240). Such techniques are described in further detail with reference to FIG. 3 and FIG. 4.

In some examples, a type of control message carrying the activation 245 may be associated with a type of RACH procedure activated by the control message. For example, the UE 115-a may be configured with common ROs 225 for CBRA and dedicated ROs 235 for CFRA. The UE 115-a may receive a paging DCI to activate the common ROs 225 for CBRA and a PDCCH order to activate the dedicated ROs 235 for CFRA. In some examples, the paging DCI may indicate activation of additional PRACH resources (e.g., the additional ROs for CBRA 230 and the additional ROs for CFRA 240) for a duration. The duration may be configured (e.g., semi-statically configured, such as according to a duration of a timer). In some examples, the PDCCH order may indicate activation of additional PRACH resources (e.g., the additional ROs for CFRA 240) for a UE 115-a in an RRC Connected mode.

In some examples (e.g., if the UE 115-a is configured with both of a dedicated RACH configuration and a common RACH configuration), the UE 115-a may be unaware of whether the paging DCI may activate the dedicated ROs 235 (e.g., and the additional ROs for CFRA 240) and whether the PDCCH order may activate the common ROs 225 (e.g., and the additional ROs for CBRA 230), or if the paging DCI is restricted to activation of the common configuration and the PDCCH order is restricted to activation of the dedicated configuration. Additionally, in examples in which the UE 115-a is configured with the common RACH configuration and is not configured with the dedicated RACH configuration, the UE 115-a may be unaware if the PDCCH order may activate the common configuration and/or how the PDCCH order may interact with activation via the paging DCI.

In some aspects, if both of the paging DCI and the PDCCH order may indicate availability of the additional PRACH resources (e.g., the additional ROs for CBRA 230 and the additional ROs for CFRA 240), a duration of the activation (e.g., a duration of validity) may be based on a type of message carrying the indication of availability. As an illustrative example, a paging DCI may indicate that the additional PRACH resources are available for 5 ms and a PDCCH order may indicate that the additional PRACH resources are available for 1 ms. In some examples, an activation timeline associated with the paging DCI may be different from (e.g., in different units than) an activation timeline associated with the PDCCH order. For example, the activation timeline associated with the paging DCI may be based on a timer (e.g., may be a duration of time) and the activation timeline associated with the PDCCH order may be a quantity of ROs (e.g., the following N ROs, without restriction to a timer), or vice-versa.

In some aspects, if the UE 115-a is configured with both of the common ROs 225 for CBRA (e.g., and/or the additional ROs for CBRA 230) and the dedicated ROs 235 for CFRA (e.g., and/or the additional ROs for CFRA 240), a PDCCH order may activate one or both of ROs associated with the common PRACH configuration (e.g., the common ROs 225 for CBRA and/or the additional ROs for CBRA 230) or the ROs associated with the dedicated PRACH configuration (e.g., the dedicated ROs 235 for CFRA and/or the additional ROs for CFRA 240). For example, the PDCCH order may indicate activation of the dedicated PRACH configuration, or the PDCCH order may include an indication of whether the PDCCH order activates the dedicated PRACH configuration or the common PRACH configuration.

In some aspects, if the UE 115-a is configured with the common ROs 225 for CBRA (e.g., and/or the additional ROs for CBRA 230) and is not configured with the dedicated ROs 235 for CFRA (e.g., and/or the additional ROs for CFRA 240), a PDCCH order may or may not activate ROs associated with the common PRACH configuration (e.g., the common ROs 225 for CBRA and/or the additional ROs for CBRA 230). For example, the PDCCH order may signal activation of the additional ROs for CBRA 230 (e.g., ROs relative to the RACH-configcommon configuration of the UE 115 while the UE 115 is in an idle mode). Additionally, or alternatively, the PDCCH order may not indicate activation of any PRACH configuration, and the UE 115-a may interpret reception of the PDCCH order without the dedicated PRACH configuration an error case.

In some aspects, if a PDCCH order may indicate activation of additional ROs for CBRA 230 (e.g., for a UE 115-a in an RRC Idle mode), a timeline of activation may be based on the PDCCH order or may be based on a type of resource activated by the PDCCH order. For example, the activation duration may be specific to PDCCH order activation. Additionally, or alternatively, the activation duration may be a timeline associated with activation via paging DCI or paging early indication (PEI) based on the activated resources being for CBRA (e.g., despite the activation message being the PDCCH message).

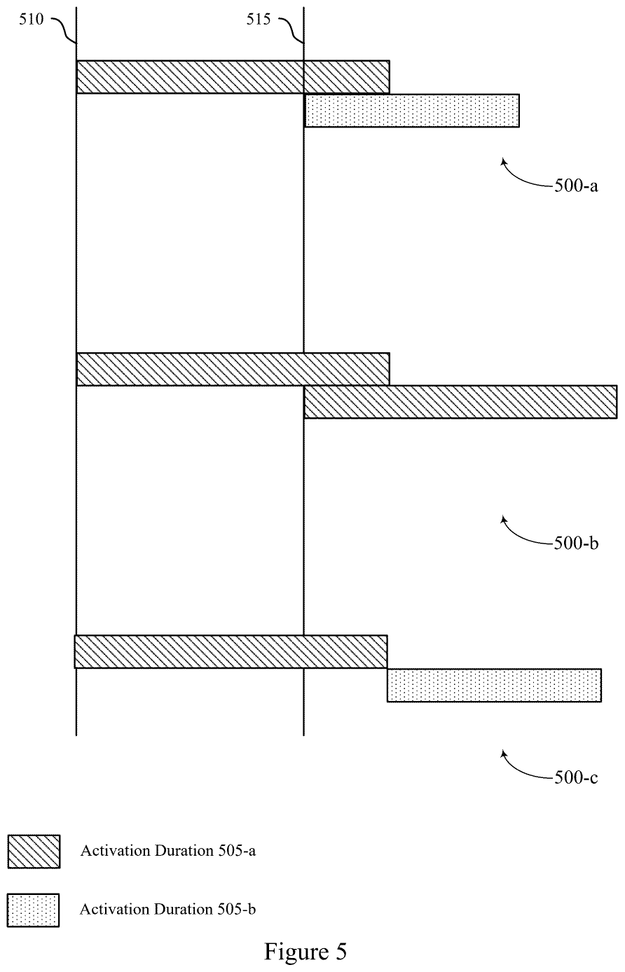

In some aspects, the UE 115-a may receive a second activation message during an activation duration that is activated by a first activation message. In such examples, the UE 115-a may extend the activation duration based on receiving the second activation message. Such techniques are described in further detail with reference to FIG. 5.

FIG. 3 shows an example of a resource diagram 300 that supports adaptation of PRACH resources. The resource diagram 300 may implement or may be implemented by aspects of the wireless communication system 100 or the signaling configuration 200. For example, the resource diagram 300 may be implemented by a UE 115 or a network entity 105, which may be examples of the corresponding devices as described with reference to FIG. 1.

In some examples, as described with reference to FIG. 2, a UE 115 may receive a configuration for one or more ROs for one or more random access procedures. For example, the UE 115 may receive a configuration for common ROs 225 associated with a CBRA procedure and dedicated ROs 235 associated with a CFRA procedure. In some examples, the UE 115 may receive configurations for additional ROs (e.g., additional ROs for CFRA 240 and additional ROs for CBRA 230). As illustrated with reference to FIG. 3, the ROs for CBRA and the ROs for CFRA may be configured in a BWP 305 (e.g., an initial BWP).

The UE 115 may receive control information (e.g., a PDCCH order message) that activates a random access procedure (e.g., the CFRA procedure). In some aspects, the PDCCH order message may activate one or more of the ROs based on satisfaction of one or more conditions. For example, based on the dedicated ROs 235 being configured in a same BWP (e.g., the initial BWP) as the common ROs 225 and based on the UE 115 receiving a configuration for the additional ROs for CBRA 230 (e.g., and not the additional ROs for CFRA 240), the PDCCH order may activate the dedicated ROs 235 and the additional ROs for CBRA 230. Additionally, or alternatively, in such examples, the PDCCH order may activate the dedicated ROs 235 and not the additional ROs for CBRA 230. That is, if single additional PRACH resources are defined with respect to the common ROs 225, the PDCCH order may or may not activate the additional ROs for CBRA 230.

Additionally, or alternatively, based on the dedicated ROs 235 being configured in a same BWP (e.g., the initial BWP) as the common ROs 225 and based on the UE 115 receiving a configuration for the additional ROs for CBRA 230 and for the additional ROs for CFRA 240, the PDCCH order may activate the dedicated ROs 235, the additional ROs for CBRA 230, and/or the additional ROs for CFRA 240. That is, if two additional PRACH resources are defined (e.g., with respect to the common ROs 225 and the dedicated ROs 235), the PDCCH order may indicate the availability of the additional ROs for CFRA 240, both of the additional ROs for CBRA 230 and the additional ROs for CFRA 240, or one of the additional ROs for CBRA 230 or the additional ROs for CFRA 240. In examples in which the PDCCH order indicates the availability of one of the additional ROs for CBRA 230 or the additional ROs for CFRA 240, the UE 115 may receive an RRC message or a preamble of the PDCCH order that indicates which of the additional ROs for CBRA 230 or the additional ROs for CFRA 240 may be activated by the PDCCH order.

FIG. 4 shows an example of a resource diagram 400 that supports adaptation of PRACH resources. The resource diagram 400 may implement or may be implemented by aspects of the wireless communication system 100, the signaling configuration 200, or the resource diagram 300. For example, the resource diagram 400 may be implemented by a UE 115 or a network entity 105, which may be examples of the corresponding devices as described with reference to FIG. 1.

In some examples, as described with reference to FIG. 2, a UE 115 may receive a configuration for one or more ROs for one or more random access procedures. For example, the UE 115 may receive a configuration for common ROs 225 associated with a CBRA procedure and dedicated ROs 235 associated with a CFRA procedure. In some examples, the UE 115 may receive configurations for additional ROs (e.g., additional ROs for CFRA 240 and additional ROs for CBRA 230). As illustrated with reference to FIG. 4, the ROs for CBRA may be configured in a BWP 405-a (e.g., an initial BWP) and the ROs for CFRA may be configured in a BWP 405-b (e.g., an active BWP).

The UE 115 may receive control information (e.g., a PDCCH order message) that activates a random access procedure (e.g., the CFRA procedure). In some aspects, the PDCCH order message may activate one or more of the ROs based on satisfaction of one or more conditions. For example, based on the dedicated ROs 235 being configured in a different BWP (e.g., the active BWP) as the common ROs 225 and based on the UE 115 receiving a configuration for the additional ROs for CBRA 230 (e.g., and not the additional ROs for CFRA 240), the PDCCH order may activate the dedicated ROs 235 or the additional ROs for CBRA 230. Additionally, or alternatively, in such examples, the PDCCH order may activate the dedicated ROs 235 and not the additional ROs for CBRA 230. That is, if single additional PRACH resources are defined with respect to the common ROs 225, the PDCCH order may or may not activate the additional ROs for CBRA 230. In examples in which the PDCCH order indicates availability of the additional ROs for CBRA 230, the UE 115 may be expected to switch to the initial uplink BWP (e.g., the BWP 405-a).

Additionally, or alternatively, based on the dedicated ROs 235 being configured in a different BWP (e.g., the active BWP) as the common ROs 225 and based on the UE 115 receiving a configuration for the additional ROs for CBRA 230 and for the additional ROs for CFRA 240, the PDCCH order may activate the dedicated ROs 235, the additional ROs for CBRA 230, and/or the additional ROs for CFRA 240. That is, if two additional PRACH resources are defined (e.g., with respect to the common ROs 225 and the dedicated ROs 235), the PDCCH order may indicate the availability of the additional ROs for CFRA 240 or one of the additional ROs for CBRA 230 or the additional ROs for CFRA 240. In examples in which the PDCCH order indicates the availability of one of the additional ROs for CBRA 230 or the additional ROs for CFRA 240, the UE 115 may receive an RRC message or a preamble of the PDCCH order that indicates which of the additional ROs for CBRA 230 or the additional ROs for CFRA 240 may be activated by the PDCCH order. In examples in which the PDCCH order indicates availability of the additional ROs for CBRA 230, the UE 115 may be expected to switch to the initial uplink BWP (e.g., the BWP 405-a).

Additionally, or alternatively, based on the UE operating in the active BWP different from the initial BWP and not receiving a configuration for dedicated ROs 235 (e.g., or additional ROs for CFRA 240), and based on the UE 115 receiving a configuration for the additional ROs for CBRA 230, the PDCCH order may activate the additional ROs for CBRA 230. That is, the PDCCH order may indicate the availability the additional ROs for CBRA 230. In examples in which the UE 115 is not configured with the dedicated ROs 235, the UE 115 may be expected to switch to the initial uplink BWP (e.g., the BWP 405-a) in response to receiving the PDCCH order.

FIG. 5 shows examples of timing diagrams 500 that support adaptation of PRACH resources. The timing diagrams 500 may implement or may be implemented by aspects of the wireless communication system 100, the signaling configuration 200, the resource diagram 300, or the resource diagram 400. For example, the timing diagrams 500 may be implemented by a UE 115 or a network entity 105, which may be examples of the corresponding devices as described with reference to FIG. 1.

In some examples, as described with reference to FIG. 2, a UE 115 may receive a configuration for one or more ROs for one or more RACH procedures. For example, the UE 115 may receive a configuration for common ROs 225 associated with a CBRA procedure and dedicated ROs 235 associated with a CFRA procedure. In some examples, the UE 115 may receive configurations for additional ROs (e.g., additional ROs for CFRA 240 and additional ROs for CBRA 230). In some examples, the UE 115 may receive one or more activation messages to activate the RACH procedures. For example, the UE 115 may monitor for a paging DCI to activate the CBRA procedure, and for a PDCCH order to activate the CFRA procedure.

In some aspects, the PDCCH order may activate either of the CBRA procedure or the CFRA procedure. That is, the UE 115 may receive a paging DCI or a PDCCH order that may activate one or more common ROs (e.g., and/or one or more additional ROs defined with respect to the one or more common ROs for the CBRA procedure).

In some aspects, each type of activation (e.g., paging DCI or PDCCH order) may be associated with a respective activation duration. For example, if the UE 115 receives the paging DCI, the UE 115 may assume that the activated ROs are activated for an activation duration 505-a. If the UE 115 receives the PDCCH order, the UE 115 may assume that the activated ROs are activated for an activation duration 505-b.

In some examples, if the UE 115 receives a second activation message (e.g., a DCI such as a paging DCI or PDCCH order) during a current activation duration associated with a first activation message, the UE 115 may assume that the activation duration is extended. For example, the UE 115 may extend the activation duration based on an activation duration 505 associated with the first activation message or based on an activation duration 505 associated with the second activation message. Additionally, or alternatively, the UE 115 may waits until the current activation period (e.g., an activation duration 505 associated with the first activation message) ends, and the UE 115 may initiate an activation duration 505 associated with the second activation message upon expiration of the activation duration 505 associated with the first activation message.

For example, as illustrated with reference to a timing diagram 500-a, the UE 115 may receive a paging DCI at a time 510 that activates one or more ROs (e.g., common ROs, dedicated ROs, additional ROs defined with respect to the dedicated and/or common ROs) for the activation duration 505-a. If the UE 115 receives a PDCCH order at a time 515, the UE may assume that the activated ROs are active for the activation duration 505-b following the time 515 based on receiving a PDCCH order.

Additionally, or alternatively, as illustrated with reference to a timing diagram 500-b, the UE 115 may receive a paging DCI at a time 510 that activates one or more ROs (e.g., common ROs, dedicated ROs, additional ROs defined with respect to the dedicated and/or common ROs) for the activation duration 505-a. If the UE 115 receives a PDCCH order at a time 515, the UE may assume that the activated ROs are active for the activation duration 505-a following the time 515 based on the first activation message being the paging DCI.

Additionally, or alternatively, as illustrated with reference to a timing diagram 500-c, the UE 115 may receive a paging DCI at a time 510 that activates one or more ROs (e.g., common ROs, dedicated ROs, additional ROs defined with respect to the dedicated and/or common ROs) for the activation duration 505-a. If the UE 115 receives a PDCCH order at a time 515, the UE may assume that the activated ROs are active for the activation duration 505-b following expiration of the duration 505-a based on receiving a PDCCH order.

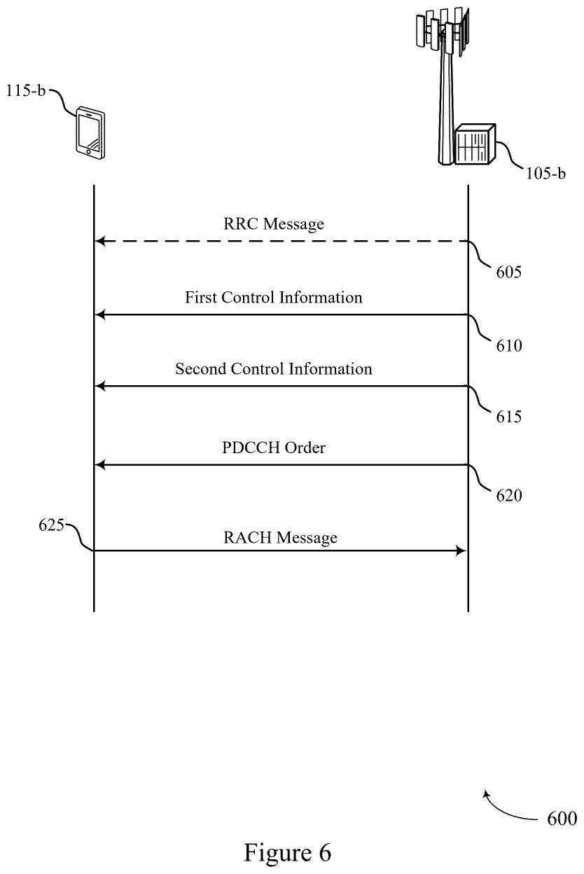

FIG. 6 shows an example of a process flow 600 that supports adaptation of PRACH resources. The process flow 600 may implement or may be implemented by aspects of the wireless communication system 100, the signaling configuration 200, the resource diagram 300, the resource diagram 400, or the timing diagrams 500. For example, the process flow 600 may be implemented by a UE 115 (e.g., a UE 115-b) or a network entity 105 (e.g., a network entity 105-b), which may be examples of the corresponding devices as described with reference to FIG. 1. As described herein, the UE 115-b and the network entity 105-a

In the following description of the process flow 600, the operations between the UE 115-b and the network entity 105-b may occur in a different order than the example order shown and, in some examples, may be performed by one or more different devices other than those shown as examples. Some operations also may be omitted from the process flow 600, and other operations may be added to the process flow 600. Further, although some operations or signaling may be shown to occur at different times for discussion purposes, these operations may actually occur at the same time.

In some examples, at 605, the network entity 105-b may transmit, to the UE 115-b, an RRC message that indicates one or more of a first set of additional ROs associated with a CBRA procedure and a second set of additional ROs associated with a CFRA procedure that may be activated by a PDCCH order message. The PDCCH order message may activate the CFRA procedure. In some examples, the indication of the additional set of ROs that may be activated by the PDCCH order message may be indicated via a preamble of the PDCCH order message.

At 610, the UE 115-b may receive, from the network entity 105-b, first control information that configures a set of common ROs for the CBRA procedure, a set of dedicated ROs for the CFRA procedure, or both. In some examples, the set of common ROs and the set of dedicated ROs may both be located in an initial BWP. Additionally, or alternatively, the set of dedicated ROs may be located in an active BWP different from the initial BWP. The first control information may be indicated via one or more control messages from the network entity 105-b (e.g., RRC messages, MAC-CE messages).

At 615, the UE 115-b may receive, from the network entity 105-b, second control information that configures the first set of additional ROs, the second set of additional ROs, or both. The second control information may be indicated via one or more control messages from the network entity 105-b (e.g., RRC messages, MAC-CE messages). The first set of additional ROs may be configured in a same BWP (e.g., the initial BWP) as the common ROs. The second set of additional ROs may be configured in a same BWP (e.g., the initial BWP or the active BWP) as the dedicated ROs.

At 620, the UE 115-b may receive the PDCCH order message. The PDCCH order message may activate the CFRA procedure. In some examples, the PDCCH order message may activate the dedicated ROs, the first set of additional ROs, and/or the second set of additional ROs based on satisfaction of one or more conditions, as described herein with reference to FIGS. 3 and 4.

For example, the PDCCH order message may activate the first set of additional ROs if the conditions of the dedicated ROs being configured in the initial BWP and the first set of additional ROs being configured by the second control information are satisfied. Additionally, or alternatively, the PDCCH order message may not activate the first set of additional ROs if the conditions of the dedicated ROs being configured in the initial BWP and the PDCCH order activating the CFRA procedure are satisfied. Additionally, or alternatively, the PDCCH order message may activate the second set of additional ROs if the conditions of the dedicated ROs being configured in the initial BWP, the first set of additional ROs being configured by the second control information, the second set of additional ROs being configured by the second control information, and the PDCCH order activating the CFRA procedure are satisfied.

Additionally, or alternatively, the PDCCH order message may activate the second set of additional ROs if the conditions of the dedicated ROs being configured in the active BWP, the first set of additional ROs being configured by the second control information, the second set of additional ROs being configured by the second control information, and the PDCCH order activating the CFRA procedure are satisfied.

Additionally, or alternatively, the PDCCH order message may activate both of the first set of additional ROs and the second set of additional ROs if the conditions of the dedicated ROs being configured in the initial BWP, the first set of additional ROs being configured by the second control information, and the second set of additional ROs being configured by the second control information are satisfied. Additionally, or alternatively, the PDCCH order message may not activate the first set of additional ROs if the conditions of the dedicated ROs being configured in the active BWP and the PDCCH order activating the CFRA procedure are satisfied.

Additionally, or alternatively, the PDCCH order message may activate one of the first set of additional ROs or the second set of additional ROs if the conditions of the dedicated ROs being configured in the active BWP, the first set of additional ROs being configured by the second control information, and the second set of additional ROs being configured by the second control information are satisfied. For example, the PDCCH order may active the set of additional ROs indicated via the RRC message or via the preamble. In such examples, the UE 115-b may switch from the active BWP to the initial BWP in response to activation of the second set of additional ROs.

At 625, the UE 115-b may transmit, and the network entity 105-b may monitor for, a RACH message (e.g., msg1 or msgA) via an activated set of ROs (e.g., the dedicated set of ROs, the first set of additional ROs, the second set of additional ROs). For example, the UE 115-b may transmit the RACH message via a BWP corresponding to the activated sets of ROs. Such techniques may enable relatively more flexible activation of ROs, which may decrease latency and increase reliability of wireless communication systems.

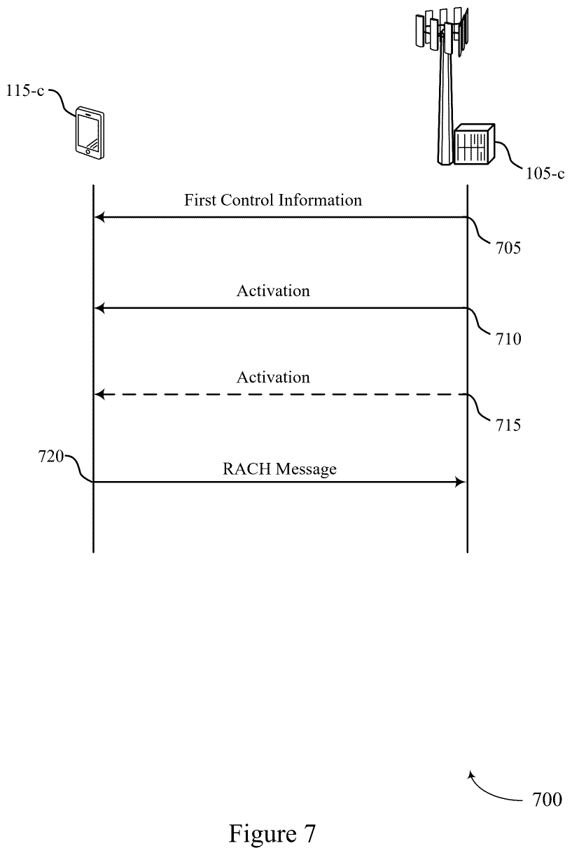

FIG. 7 shows an example of a process flow 700 that supports adaptation of PRACH resources. The process flow 700 may implement or may be implemented by aspects of the wireless communication system 100, the signaling configuration 200, the resource diagram 300, the resource diagram 400, the timing diagrams 500, or the process flow 600. For example, the process flow 700 may be implemented by a UE 115 (e.g., a UE 115-c) or a network entity 105 (e.g., a network entity 105-c), which may be examples of the corresponding devices as described with reference to FIG. 1.

In the following description of the process flow 700, the operations between the UE 115-b and the network entity 105-b may occur in a different order than the example order shown and, in some examples, may be performed by one or more different devices other than those shown as examples. Some operations also may be omitted from the process flow 700, and other operations may be added to the process flow 700. Further, although some operations or signaling may be shown to occur at different times for discussion purposes, these operations may actually occur at the same time.

At 705, the network entity 105-c may transmit, to the UE 115-c, first control information that configures a set of common ROs and a set of additional ROs associated with the set of common ROs. In some examples, the network entity 105-c may further configure a set of dedicated ROs and a second set of additional ROs associated with the set of dedicated ROs. The set of common ROs may be associated with a CBRA procedure and the set of dedicated ROs may be associated with a CFRA procedure. The first control information may be indicated via one or more control messages from the network entity 105-c (e.g., RRC messages, MAC-CE messages).

At 710, the network entity 105-c may transmit, to the UE 115-c, second control information that triggers a random access procedure (e.g., the CBRA procedure or the CFRA procedure). The second control information may activate the set of common ROs, the set of additional ROs, or both. Additionally, or alternatively, the second control information may activate the set of dedicated ROs, the second set of additional ROs, or both. The second control information may be indicated via one or more control messages from the network entity 105-c (e.g., RRC messages, MAC-CE messages, DCI messages, PDCCH messages).

In some examples, a duration of the activation of the activated ROs may correspond to a type of the second control information. For example, if the second control information is a paging DCI, the activation may be associated with a first duration. If the second control information is a PDCCH order, the activation may be associated with a second duration (e.g., different from the first duration). In some examples, the first duration may be an amount of time and the second duration may be a quantity of ROs (e.g., or vice-versa). Additionally, or alternatively, both of the first and second duration may be quantities of ROs or amounts of time.

In some examples, at 715, the UE 115-c may receive, from the network entity 105-c, third control information (e.g., an additional paging DCI or PDCCH order) that triggers the random access procedure. The third control information may indicate a second activation of the activated ROs. For example, the duration of the activation may be extended in response to the second activation. The extended duration of the activation may be equal to a sum of the duration indicated via the second control information and the duration indicated via the third control information, or may be equal to a sum of the duration indicated via the third control information and an elapsed portion of the duration indicated via the second control information.

At 720, the UE 115-c may transmit a RACH message via the set of common ROs or the set of additional ROs in accordance with the second control information (e.g., during the duration of activation and via the activated ROs). For example, if the second control message is the PDCCH order message, the UE 115-c may transmit the RACH message during the second duration. If the second control message is the paging DCI, the UE 115-c may transmit the RACH message during the first duration. Such techniques may enable relatively more flexible activation of ROs, which may decrease latency and increase reliability of wireless communication systems.

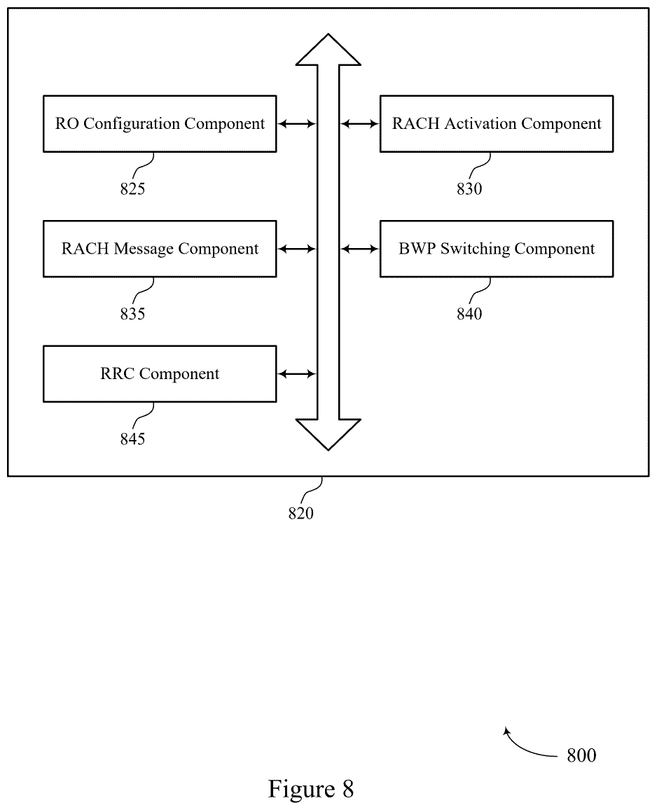

FIG. 8 shows an example of a processing system 820 that supports adaptation of PRACH resources. A processing system 820 may be an example of a processing system 140 (such as of a UE 115) and may include a RO configuration component 825, a RACH activation component 830, a RACH message component 835, a BWP switching component 840, an RRC component 845, or any combination thereof. A processing system 820, or various component thereof, may be an example of means for performing (such as a means for causing a UE 115 to perform) various techniques described herein.

The RO configuration component 825 may be configured to cause the UE 115 to receive first control information that configures a set of common ROs for CBRA, a set of dedicated ROs for CFRA, or both. In some examples, the RO configuration component 825 may be configured to cause the UE 115 to receive second control information that configures a first set of additional ROs associated with the CBRA, a second set of additional ROs associated with the CFRA, or both. The RACH activation component 830 may be configured to cause the UE 115 to receive a PDCCH order that activates a CFRA procedure, where the PDCCH order is configured to activate the set of dedicated ROs, the first set of additional ROs, the second set of additional ROs, or any combination thereof based on satisfaction of one or more conditions. The RACH message component 835 may be configured to cause the UE 115 to transmit a random access message via the set of dedicated ROs, the first set of additional ROs, or the second set of additional ROs in accordance with the PDCCH order.

In some examples, the PDCCH order is configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the second control information configures the first set of additional ROs associated with the CBRA.

In some examples, the PDCCH order is not configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the PDCCH order activates the CFRA procedure.

In some examples, the PDCCH order is configured to activate the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the second set of additional ROs associated with the CFRA, and the PDCCH order activates the CFRA procedure.

In some examples, the PDCCH order is configured to activate the second set of additional ROs associated with the CFRA procedure when the one or more conditions include that the first control information configures the set of common ROs for CBRA in an initial BWP, the first control information configures the set of dedicated ROs for CFRA in an active BWP different from the initial BWP, the second control information configures the second set of additional ROs associated with the CFRA, and the PDCCH order activates the CFRA procedure.

In some examples, the PDCCH order is configured to activate both of the first set of additional ROs associated with the CBRA procedure and the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

In some examples, the PDCCH order is configured to activate one of the first set of additional ROs associated with the CBRA procedure or the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

In some examples, the RRC component 845 may be configured to cause the UE 115 to receive a radio resource control message that indicates the one of the first set of additional ROs or the second set of additional ROs to be activated by the PDCCH order, where the one or more conditions include the indication.

In some examples, a preamble associated with the PDCCH order indicates the one of the first set of additional ROs or the second set of additional ROs to be activated by the PDCCH order. In some examples, the one or more conditions include the indication.

In some examples, the PDCCH order is not configured to activate the first set of additional ROs associated with the CBRA procedure when the one or more conditions include that the first control information configures the set of common ROs for CBRA in an initial BWP, the first control information configures the set of dedicated ROs for CFRA in an active BWP different from the initial BWP, and the PDCCH order activates the CFRA procedure.

In some examples, the PDCCH order is configured to activate the first set of additional ROs associated with the CBRA procedure when the one or more conditions include that the first control information configures the set of common ROs for CBRA in an initial BWP, and the BWP switching component 840 may be configured to cause the UE 115 to switch from the active BWP to the initial BWP in accordance with the activation of the first set of additional ROs.

In some examples, the RO configuration component 825 may be configured to cause the UE 115 to receive first control information that configures a set of common ROs and a set of additional ROs. In some examples, the RACH activation component 830 may be configured to cause the UE 115 to receive second control information that triggers a random access procedure, where the second control information activates, for the random access procedure, the set of common ROs, the set of additional ROs, or both, and where a duration of activation is associated with a type of message that carries the second control information. In some examples, the RACH message component 835 may be configured to cause the UE 115 to transmit a random access message via the set of common ROs or the set of additional ROs in accordance with the second control information.

In some examples, the duration of the activation includes a first duration when the type of message is a paging DCI message or a second duration when the type of message is a PDCCH order.

In some examples, the second duration is based on a timer and the first duration is based on a quantity of ROs.

In some examples, the first duration is based on a timer and the second duration is based on a quantity of ROs.

In some examples, to support transmitting the random access message, the RACH message component 835 may be configured to cause the UE 115 to transmit the random access message during the first duration in accordance with the second control information activating the set of additional ROs.

In some examples, to support transmitting the random access message, the RACH message component 835 may be configured to cause the UE 115 to transmit the random access message during the second duration in accordance with the second control information being the PDCCH order.

In some examples, the RACH activation component 830 may be configured to cause the UE 115 to receive, during the duration of activation, third control information that triggers the random access procedure, where the third control information indicates a second activation of the set of common ROs, the set of additional ROs, or both, and where the duration activation is extended in accordance with receiving the third control information.

In some examples, the extended duration includes a sum of an elapsed portion of a first duration indicated by the second control information and a second duration indicated by the third control information.

In some examples, the extended duration includes a sum of a first duration indicated by the second control information and a second duration indicated by the third control information.

A processing system 820 may include or be a component of one or more chips, systems-on-chips (SoCs), chipsets, packages, components, or devices that individually or collectively constitute or include a processing system. A processing system 820 may interface with other components of a processing system 820. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a processing system 820).

By including or configuring a processing system 820 for operation in a processing system 820 as described herein, the processing system 820 may support techniques for activation of ROs, which may enable more efficient utilization of communication resources.

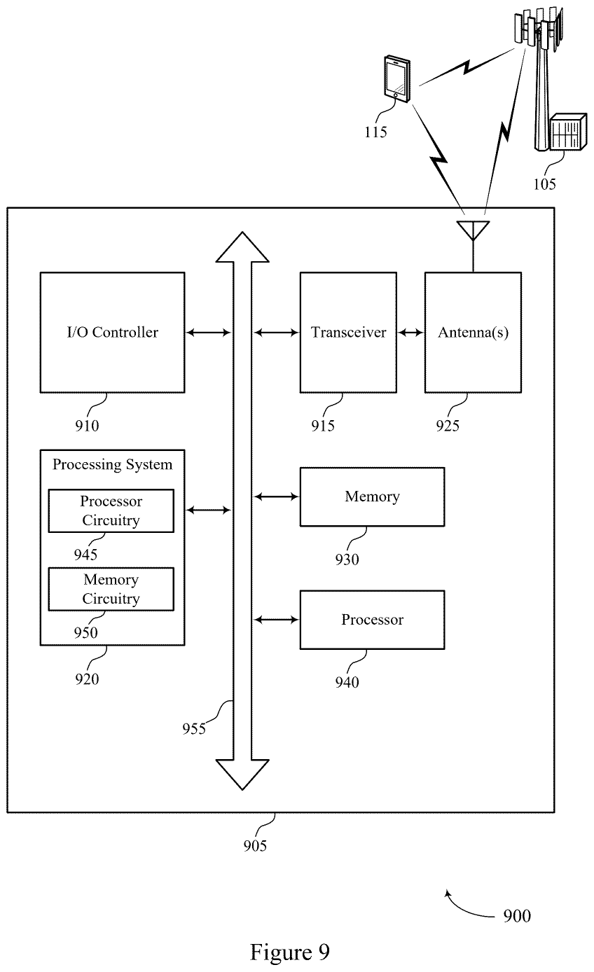

FIG. 9 shows an example of a system 900 including a device 905 that supports adaptation of PRACH resources. The device 905 may be an example of or include components of UE 115. The device 905 may communicate (such as wirelessly) with one or more other devices (such as network entities 105, UEs 115). The device 905 may include components for transmitting and receiving communication, which may include a processing system 920, an input/output (I/O) controller, such as an I/O controller 910, a transceiver 915, antenna(s) 925, a memory 930, and a processor 940. Components of the device 905 may be coupled (such as operatively, communicatively, functionally, electronically, electrically, in electronic communication) a bus 955.

The transceiver 915 may support bi-directional communication via antenna(s) 925, and may support transmission operations, reception operations, or both, as described herein. The transceiver 915 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 905). The transceiver 915 may modulate symbols and provide the modulated symbols to antenna(s) 925 for transmission, and demodulate symbols from signals received using antenna(s) 925.

The processor 940 may be a general-purpose processing component that supports various operations (such as applications) of the device 905. The memory 930 may be a general-purpose storage component that stores code executable by the processor 940. Such code may include instructions that, when executed by the processor 940, cause the device 905 to perform various functions (such as to support an application of the device 905). The I/O controller 910 may manage inputs and outputs for the device 905, may manage peripherals not integrated into the device 905, or may represent a physical connection (such as port) to an external peripheral. The processor 940 may interact with a modem, a keyboard, a mouse, a touchscreen, or other device (such as via I/O controller 910). In some implementations, a user may interact with the device 905 via the I/O controller 910 or via hardware components controlled by the I/O controller 910.

The processing system 920 may be an example of a processing system 140 or a processing system 800. For example, the processing system 920 may include processor circuitry 945 and memory circuitry 950 that stores code, and may be configured to cause the device 905 to perform operations that support adaptation of PRACH resources. Although the processing system 920 is illustrated as a separate component, which may involve a separate chip, chipset, or other module, in some implementations, one or more functions described with reference to the processing system 920 may be supported by or performed by a transceiver 915, antenna(s) 925, a processor 940, memory 930, or any combination thereof, such that a processing system 920 may include one or more of a transceiver 915, antenna(s) 925, a processor 940, memory 930, or any combination thereof.

By including or configuring the processing system 920 for operation in the device 905 as described herein, may support techniques for activation of ROs, which may enable improved communication reliability, reduced latency, and improved coordination between devices.

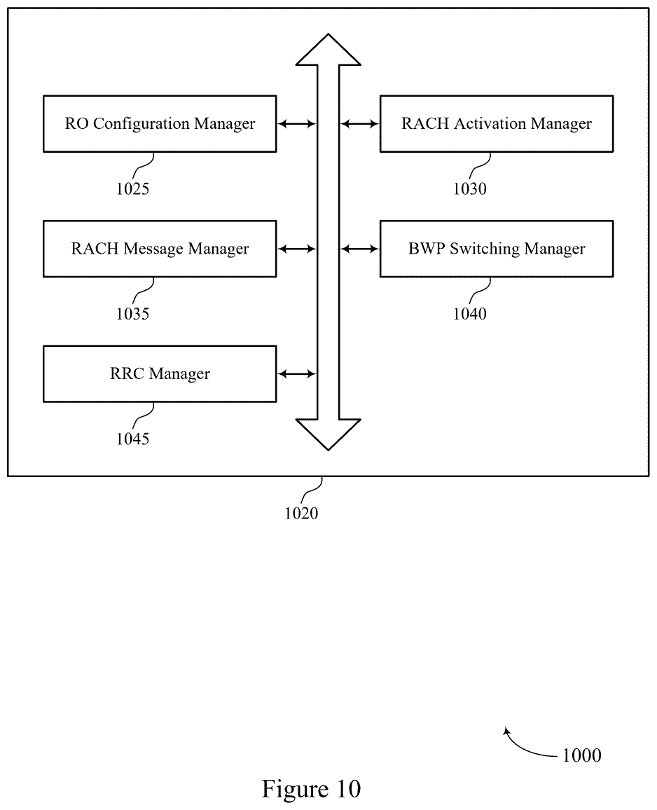

FIG. 10 shows an example of a processing system 1020 that supports adaptation of PRACH resources. A processing system 1020 may be an example of a processing system 145 (such as network entity 105) and may include a RO configuration manager 1025, a RACH activation manager 1030, a RACH message manager 1035, an RRC manager 1045, or any combination thereof. A processing system 1020, or various component thereof, may be an example of means for performing (such as a means for causing a network entity 105 to perform) various techniques described herein.

The RO configuration manager 1025 may be configured to cause the network entity 105 to output first control information that configures a set of common ROs for CBRA, a set of dedicated ROs for CFRA, or both. In some examples, the RO configuration manager 1025 may be configured to cause the network entity 105 to output second control information that configures a first set of additional ROs associated with the CBRA, a second set of additional ROs associated with the CFRA, or both. The RACH activation manager 1030 may be configured to cause the network entity 105 to output a PDCCH order that activates a CFRA procedure, where the PDCCH order is configured to activate the set of dedicated ROs, the first set of additional ROs, the second set of additional ROs, or any combination thereof based on satisfaction of one or more conditions. The RACH message manager 1035 may be configured to cause the network entity 105 to monitor for a random access message via the set of dedicated ROs, the first set of additional ROs, or the second set of additional ROs in accordance with the PDCCH order.

In some examples, the PDCCH order is configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the second control information configures the first set of additional ROs associated with the CBRA.

In some examples, the PDCCH order is not configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the PDCCH order activates the CFRA procedure.

In some examples, the PDCCH order is configured to activate the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the second set of additional ROs associated with the CFRA, and the PDCCH order activates the CFRA procedure.

In some examples, the PDCCH order is configured to activate the second set of additional ROs associated with the CFRA procedure when the one or more conditions include that the first control information configures the set of common ROs for CBRA in an initial BWP, the first control information configures the set of dedicated ROs for CFRA in an active BWP different from the initial BWP, the second control information configures the second set of additional ROs associated with the CFRA, and the PDCCH order activates the CFRA procedure.

In some examples, the PDCCH order is configured to activate both of the first set of additional ROs associated with the CBRA procedure and the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

In some examples, the PDCCH order is configured to activate one of the first set of additional ROs associated with the CBRA procedure or the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

In some examples, the RRC manager 1045 may be configured to cause the network entity 105 to output a radio resource control message that indicates the one of the first set of additional ROs or the second set of additional ROs to be activated by the PDCCH order, where the one or more conditions include the indication.

In some examples, a preamble associated with the PDCCH order indicates the one of the first set of additional ROs or the second set of additional ROs to be activated by the PDCCH order. In some examples, the one or more conditions include the indication.

In some examples, the PDCCH order is not configured to activate the first set of additional ROs associated with the CBRA procedure when the one or more conditions include that the first control information configures the set of common ROs for CBRA in an initial BWP, the first control information configures the set of dedicated ROs for CFRA in an active BWP different from the initial BWP, and the PDCCH order activates the CFRA procedure.

In some examples, the PDCCH order is configured to activate the first set of additional ROs associated with the CBRA procedure when the one or more conditions include that the first control information configures the set of common ROs for CBRA in an initial BWP, and the BWP switching manager 1040 may be configured to cause the network entity 105 to switch from the active BWP to the initial BWP in accordance with the activation of the first set of additional ROs.

In some examples, the RO configuration manager 1025 may be configured to cause the network entity 105 to output first control information that configures a set of common ROs and a set of additional ROs. In some examples, the RACH activation manager 1030 may be configured to cause the network entity 105 to output second control information that triggers a random access procedure, where the second control information activates, for the random access procedure, the set of common ROs, the set of additional ROs, or both, and where a duration of activation is associated with a type of message that carries the second control information. In some examples, the RACH message manager 1035 may be configured to cause the network entity 105 to monitor for a random access message via the set of common ROs or the set of additional ROs in accordance with the second control information.

In some examples, the duration of the activation includes a first duration when the type of message is a paging DCI message or a second duration when the type of message is a PDCCH order.

In some examples, the second duration is based on a timer and the first duration is based on a quantity of ROs.

In some examples, the first duration is based on a timer and the second duration is based on a quantity of ROs.

In some examples, to support monitoring for the random access message, the RACH message manager 1035 may be configured to cause the network entity 105 to monitor for the random access message during the first duration in accordance with the second control information activating the set of additional ROs.

In some examples, to support monitoring for the random access message, the RACH message manager 1035 may be configured to cause the network entity 105 to monitor for the random access message during the second duration in accordance with the second control information being the PDCCH order.

In some examples, the RACH activation manager 1030 may be configured to cause the network entity 105 to output, during the duration of activation, third control information that triggers the random access procedure, where the third control information indicates a second activation of the set of common ROs, the set of additional ROs, or both, and where the duration activation is extended in accordance with receiving the third control information.

In some examples, the extended duration includes a sum of an elapsed portion of a first duration indicated by the second control information and a second duration indicated by the third control information.

In some examples, the extended duration includes a sum of a first duration indicated by the second control information and a second duration indicated by the third control information.

A processing system 1020 may include or be an example of one or more chips, SoCs, chipsets, packages, components, or devices that individually or collectively constitute or include a processing system. A processing system 1020 may interface with other components of a network entity 105. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a network entity 105). Operations described herein with reference to the processing system 1020, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1020 for operation in a processing system 1020 as described herein, the processing system 1020 may support techniques for activation of ROs, which may enable more efficient utilization of communication resources.

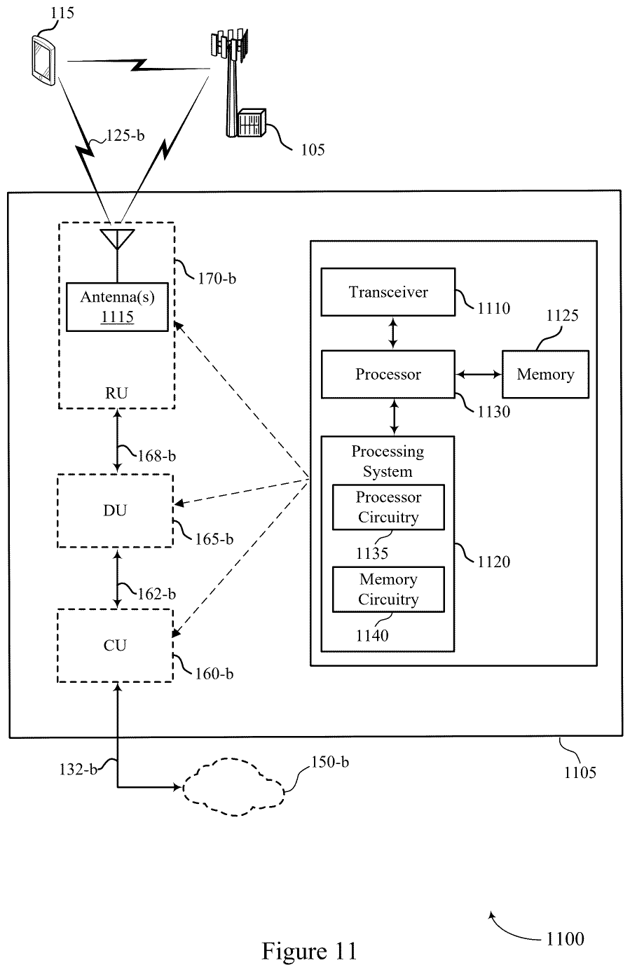

FIG. 11 shows an example of a system 1100 including a device 1105 that supports adaptation of PRACH resources. The device 1105 may communicate (such as via one or more wired interfaces or one or more wireless interfaces) with other network devices or network equipment such as a core network 150-b, other network entities 105, UEs 115, or any combination thereof. The device 1105 may include components for transmitting and receiving communication, which may include a processing system 1120, a transceiver 1110, antenna(s) 1115, a memory 1125, and a processor 1130. Components of the device 1105 may be coupled (such as operatively, communicatively, functionally, electronically, electrically, in electronic communication) via one or more interfaces.

The transceiver 1110 may communicate bi-directionally with another transceiver via wired or wireless links, and may support transmission operations, reception operations, or both, as described herein. The transceiver 1110 may include a modem to modulate and demodulate signals, to provide the modulated signals for transmission (such as via antenna(s) 1115, via a wired interface), and to demodulate received signals (such as received via antenna(s) 1115, received via a wired interface). The transceiver 1110 may be operable to support communication via one or more communication links (such as a communication link 125-b, a backhaul link 132-b, a midhaul link 162-b, fronthaul link 168-b).

The processor 1130 may be a general-purpose processing component that supports various operations (such as applications) of the device 1105. The memory 1125 may be a general-purpose storage component that stores code executable by the processor 1130. Such code may include instructions that, when executed by the processor 1130, cause the device 1105 to perform various functions (such as to support an application of the device 1105).

For examples in which the device 1105 is a network entity 105 in a disaggregated architecture, one or more components of the device 1105 may be located at one or more of a CU 160-b, a DU 165-b, or an RU 170-b, one or more of which may include aspects of the processing system 1120, the processor 1130, the memory 1125, or the transceiver 1110. Functions of the device 1105 may be performed at different components or an operation may be divided between different components (such as different functions being supported by aspects of the CU 160-b, the DU 165-b, or the RU 170-b, the transceiver 1110, the processor 1130, the memory 1125, the processing system 1120, or any combination thereof). For example, the processing system 1120 may be a component of one or more of the CU 160-b, the DU 165-b, or the RU 170-b. In some examples, interfaces between components of device 1105 (such as CU 160-b, DU 165-b, RU 170-b) may support communication at a protocol layer or between protocol layers of a protocol stack.

In some examples, the processing system 1120 may manage aspects of communication with the core network 150-b (such as via a backhaul link 132). For example, the processing system 1120 may manage the transfer of data communication for UEs 115 with a gateway of the core network 150-b. In some examples, the processing system 1120 may manage communication with one or more other network entities 105 and may include a controller or scheduler for controlling communication with UEs 115 (such as in cooperation with the one or more other network entities 105). In some examples, the processing system 1120 may support an interface (such as X2 interface, Xn interface) to provide communication between network entities 105.

The processing system 1120 may be an example of a processing system 145 or a processing system 1000. For example, the processing system 1120 may include processor circuitry 1135 and memory circuitry 1140 that stores code, and the processing system 1120 may be configured to cause the device 1105 to perform operations that support adaptation of PRACH resources. Although the processing system 1120 is illustrated as a separate component, which may involve a separate chip, chipset, or other module, in some implementations, one or more functions described with reference to the processing system 1120 may be supported by or performed by a transceiver 1110, antenna(s) 1115, a processor 1130, memory 1125, or any combination thereof, such that a processing system 1120 may include one or more of a transceiver 1110, antenna(s) 1115, a processor 1130, memory 1125, or any combination thereof. Further, processor circuitry 1135 and memory circuitry 1140 each may be implemented at the device 1105 in accordance with an aggregated architecture, or the processor circuitry 1135 and the memory circuitry 1140 may be implemented at one or more of a CU 160-b, a DU 165-b, or an RU 170-b in accordance with a disaggregated architecture.

By including or configuring the processing system 1120 for operation in the device 1105 as described herein, may support techniques for activation of ROs, which may enable improved communication reliability, reduced latency, and improved coordination between devices.

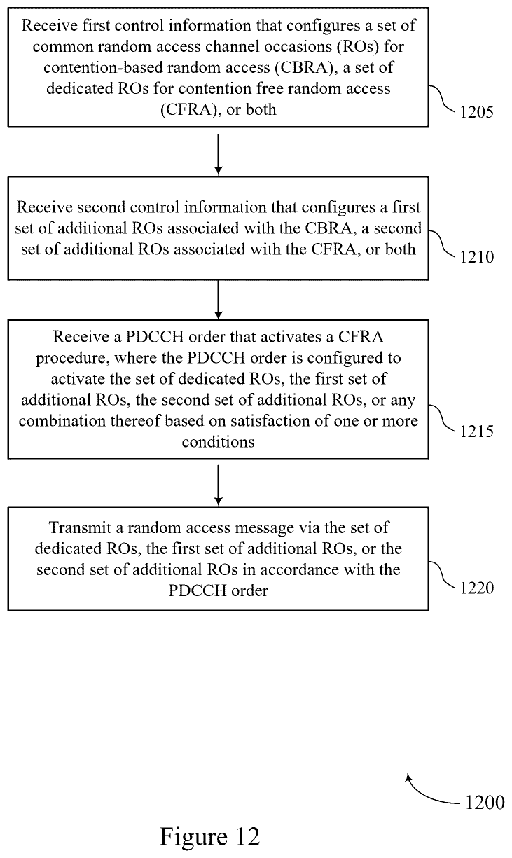

FIG. 12 shows an example of a method 1200 that supports adaptation of PRACH resources. Operations of the method 1200 may be performed by a UE or its components (such as using a processing system configured to cause the UE 115 to perform one or more of the operations) as described herein.

At 1205, the method may include receiving first control information that configures a set of common ROs for CBRA, a set of dedicated ROs for CFRA, or both. In some examples, aspects of the operations of 1205 may be performed by a RO configuration component 825.

At 1210, the method may include receiving second control information that configures a first set of additional ROs associated with the CBRA, a second set of additional ROs associated with the CFRA, or both. In some examples, aspects of the operations of 1210 may be performed by a RO configuration component 825.

At 1215, the method may include receiving a PDCCH order that activates a CFRA procedure, where the PDCCH order is configured to activate the set of dedicated ROs, the first set of additional ROs, the second set of additional ROs, or any combination thereof based on satisfaction of one or more conditions. In some examples, aspects of the operations of 1215 may be performed by a RACH activation component 830.

At 1220, the method may include transmitting a random access message via the set of dedicated ROs, the first set of additional ROs, or the second set of additional ROs in accordance with the PDCCH order. In some examples, aspects of the operations of 1220 may be performed by a RACH message component 835.

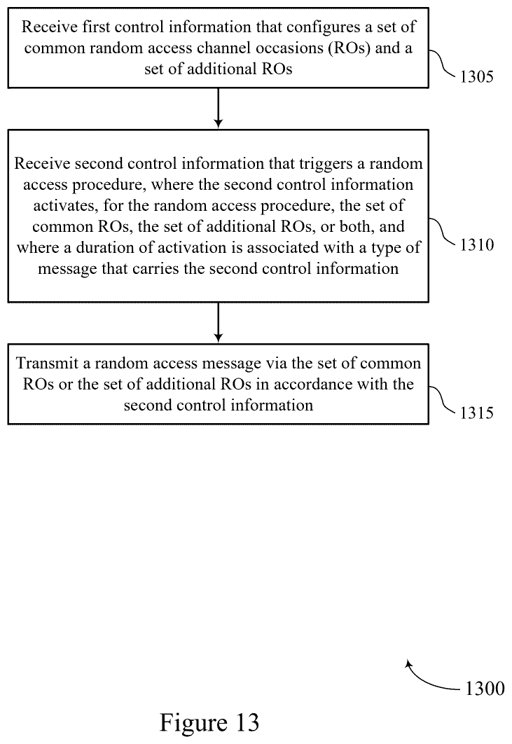

FIG. 13 shows an example of a method 1300 that supports adaptation of PRACH resources. Operations of the method 1300 may be performed by a UE or its components (such as using a processing system configured to cause the UE 115 to perform one or more of the operations) as described herein.

At 1305, the method may include receiving first control information that configures a set of common ROs and a set of additional ROs. In some examples, aspects of the operations of 1305 may be performed by a RO configuration component 825.

At 1310, the method may include receiving second control information that triggers a random access procedure, where the second control information activates, for the random access procedure, the set of common ROs, the set of additional ROs, or both, and where a duration of activation is associated with a type of message that carries the second control information. In some examples, aspects of the operations of 1310 may be performed by a RACH activation component 830.

At 1315, the method may include transmitting a random access message via the set of common ROs or the set of additional ROs in accordance with the second control information. In some examples, aspects of the operations of 1315 may be performed by a RACH message component 835.

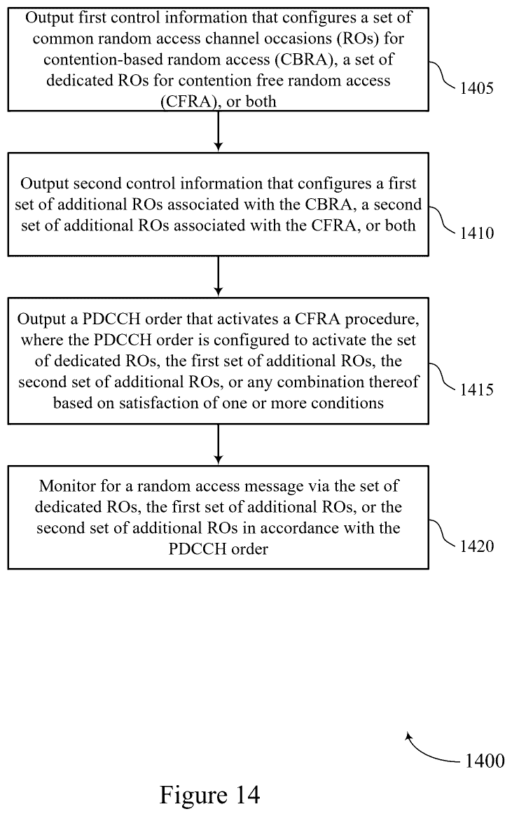

FIG. 14 shows an example of a method 1400 that supports adaptation of PRACH resources. Operations of the method 1400 may be performed by a network entity 105 or its components (such as using a processing system configured to cause the network entity to perform one or more operations) as described herein.

At 1405, the method may include outputting first control information that configures a set of common ROs for CBRA, a set of dedicated ROs for CFRA, or both. In some examples, aspects of the operations of 1405 may be performed by a RO configuration manager 1025.

At 1410, the method may include outputting second control information that configures a first set of additional ROs associated with the CBRA, a second set of additional ROs associated with the CFRA, or both. In some examples, aspects of the operations of 1410 may be performed by a RO configuration manager 1025.

At 1415, the method may include outputting a PDCCH order that activates a CFRA procedure, where the PDCCH order is configured to activate the set of dedicated ROs, the first set of additional ROs, the second set of additional ROs, or any combination thereof based on satisfaction of one or more conditions. In some examples, aspects of the operations of 1415 may be performed by a RACH activation manager 1030.

At 1420, the method may include monitoring for a random access message via the set of dedicated ROs, the first set of additional ROs, or the second set of additional ROs in accordance with the PDCCH order. In some examples, aspects of the operations of 1420 may be performed by a RACH message manager 1035.

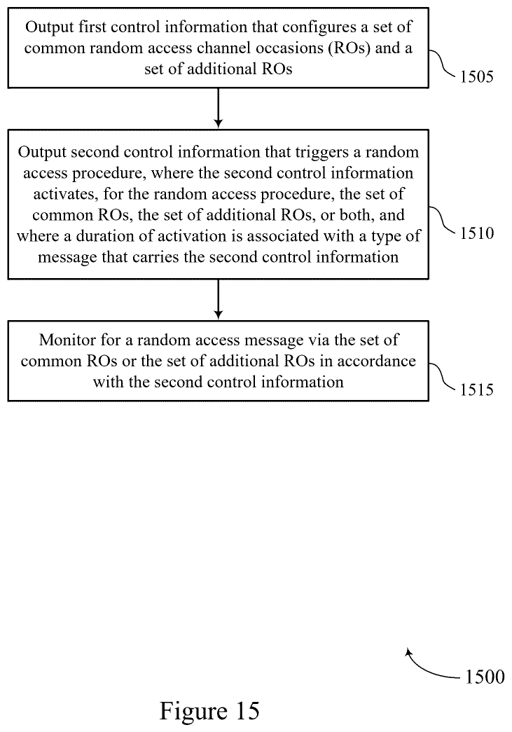

FIG. 15 shows an example of a method 1500 that supports adaptation of PRACH resources. Operations of the method 1500 may be performed by a network entity 105 or its components (such as using a processing system configured to cause the network entity to perform one or more operations) as described herein.

At 1505, the method may include outputting first control information that configures a set of common ROs and a set of additional ROs. In some examples, aspects of the operations of 1505 may be performed by a RO configuration manager 1025.

At 1510, the method may include outputting second control information that triggers a random access procedure, where the second control information activates, for the random access procedure, the set of common ROs, the set of additional ROs, or both, and where a duration of activation is associated with a type of message that carries the second control information. In some examples, aspects of the operations of 1510 may be performed by a RACH activation manager 1030.

At 1515, the method may include monitoring for a random access message via the set of common ROs or the set of additional ROs in accordance with the second control information. In some examples, aspects of the operations of 1515 may be performed by a RACH message manager 1035.

Implementation examples are described in the following numbered clauses:

Aspect 1: A method for wireless communication at a network entity, comprising: receiving first control information that configures a set of common ROs for CBRA, a set of dedicated ROs for CFRA, or both; receiving second control information that configures a first set of additional ROs associated with the CBRA, a second set of additional ROs associated with the CFRA, or both; receiving a PDCCH order that activates a CFRA procedure, wherein the PDCCH order is configured to activate the set of dedicated ROs, the first set of additional ROs, the second set of additional ROs, or any combination thereof based on satisfaction of one or more conditions; and transmitting a random access message via the set of dedicated ROs, the first set of additional ROs, or the second set of additional ROs in accordance with the PDCCH order.

Aspect 2: The method of aspect 1, wherein the PDCCH order is configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the second control information configures the first set of additional ROs associated with the CBRA.

Aspect 3: The method of any of aspects 1 through 2, wherein the PDCCH order is not configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the PDCCH order activates the CFRA procedure.

Aspect 4: The method of any of aspects 1 through 3, wherein the PDCCH order is configured to activate the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the second set of additional ROs associated with the CFRA, and the PDCCH order activates the CFRA procedure.

Aspect 5: The method of any of aspects 1 through 4, wherein the PDCCH order is configured to activate the second set of additional ROs associated with the CFRA procedure when the one or more conditions include that the first control information configures the set of common ROs for CBRA in an initial BWP, the first control information configures the set of dedicated ROs for CFRA in an active BWP different from the initial BWP, the second control information configures the second set of additional ROs associated with the CFRA, and the PDCCH order activates the CFRA procedure.

Aspect 6: The method of any of aspects 1 through 5, wherein the PDCCH order is configured to activate both of the first set of additional ROs associated with the CBRA procedure and the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

Aspect 7: The method of any of aspects 1 through 6, wherein the PDCCH order is configured to activate one of the first set of additional ROs associated with the CBRA procedure or the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

Aspect 8: The method of aspect 7, further comprising: receiving a radio resource control message that indicates the one of the first set of additional ROs or the second set of additional ROs to be activated by the PDCCH order, wherein the one or more conditions comprise the indication.

Aspect 9: The method of any of aspects 7 through 8, wherein a preamble associated with the PDCCH order indicates the one of the first set of additional ROs or the second set of additional ROs to be activated by the PDCCH order, the one or more conditions comprise the indication.

Aspect 10: The method of any of aspects 1 through 9, wherein the PDCCH order is not configured to activate the first set of additional ROs associated with the CBRA procedure when the one or more conditions include that the first control information configures the set of common ROs for CBRA in an initial BWP, the first control information configures the set of dedicated ROs for CFRA in an active BWP different from the initial BWP, and the PDCCH order activates the CFRA procedure.

Aspect 11: The method of any of aspects 1 through 10, wherein the PDCCH order is configured to activate the first set of additional ROs associated with the CBRA procedure when the one or more conditions include that the first control information configures the set of common ROs for CBRA in an initial BWP, the first control information configures the set of dedicated ROs for CFRA in an active BWP different from the initial BWP, the second control information configures the first set of additional ROs in the initial BWP, and the PDCCH order activates the CFRA procedure, the method further comprising: switching from the active BWP to the initial BWP in accordance with the activation of the first set of additional ROs.

Aspect 12: A method for wireless communication at a network entity, comprising: receiving first control information that configures a set of common ROs and a set of additional ROs; receiving second control information that triggers a random access procedure, wherein the second control information activates, for the random access procedure, the set of common ROs, the set of additional ROs, or both, and wherein a duration of activation is associated with a type of message that carries the second control information; and transmitting a random access message via the set of common ROs or the set of additional ROs in accordance with the second control information.

Aspect 13: The method of aspect 12, wherein the duration of the activation includes a first duration when the type of message is a paging DCI message or a second duration when the type of message is a PDCCH order.

Aspect 14: The method of aspect 13, wherein the second duration is based on a timer and the first duration is based on a quantity of ROs.

Aspect 15: The method of any of aspects 13 through 14, wherein the first duration is based on a timer and the second duration is based on a quantity of ROs.

Aspect 16: The method of any of aspects 13 through 15, wherein transmitting the random access message comprises: transmitting the random access message during the first duration in accordance with the second control information activating the set of additional ROs.

Aspect 17: The method of any of aspects 13 through 16, wherein transmitting the random access message comprises: transmitting the random access message during the second duration in accordance with the second control information being the PDCCH order.

Aspect 18: The method of any of aspects 12 through 17, further comprising: receiving, during the duration of activation, third control information that triggers the random access procedure, wherein the third control information indicates a second activation of the set of common ROs, the set of additional ROs, or both, and wherein the duration activation is extended in accordance with receiving the third control information.

Aspect 19: The method of aspect 18, wherein the extended duration comprises a sum of an elapsed portion of a first duration indicated by the second control information and a second duration indicated by the third control information.

Aspect 20: The method of any of aspects 18 through 19, wherein the extended duration comprises a sum of a first duration indicated by the second control information and a second duration indicated by the third control information.

Aspect 21: A method for wireless communication at a network entity, comprising: outputting first control information that configures a set of common ROs for CBRA, a set of dedicated ROs for CFRA, or both; outputting second control information that configures a first set of additional ROs associated with the CBRA, a second set of additional ROs associated with the CFRA, or both; outputting a PDCCH order that activates a CFRA procedure, wherein the PDCCH order is configured to activate the set of dedicated ROs, the first set of additional ROs, the second set of additional ROs, or any combination thereof based on satisfaction of one or more conditions; and monitoring for a random access message via the set of dedicated ROs, the first set of additional ROs, or the second set of additional ROs in accordance with the PDCCH order.

Aspect 22: The method of aspect 21, wherein the PDCCH order is configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the second control information configures the first set of additional ROs associated with the CBRA.

Aspect 23: The method of any of aspects 21 through 22, wherein the PDCCH order is not configured to activate the first set of additional ROs associated with the CBRA procedure when the one or more conditions include that the first control information configures the set of common ROs for CBRA in an initial BWP, the first control information configures the set of dedicated ROs for CFRA in the initial BWP, and the PDCCH order activates the CFRA procedure.

Aspect 24: The method of any of aspects 21 through 23, wherein the PDCCH order is configured to activate the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the second set of additional ROs associated with the CFRA, and the PDCCH order activates the CFRA procedure.

Aspect 25: The method of any of aspects 21 through 24, wherein the PDCCH order is configured to activate the second set of additional ROs associated with the CFRA procedure when the one or more conditions include that the first control information configures the set of common ROs for CBRA in an initial BWP, the first control information configures the set of dedicated ROs for CFRA in an active BWP different from the initial BWP, the second control information configures the second set of additional ROs associated with the CFRA, and the PDCCH order activates the CFRA procedure.

Aspect 26: The method of any of aspects 21 through 25, wherein the PDCCH order is configured to activate both of the first set of additional ROs associated with the CBRA procedure and the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

Aspect 27: The method of any of aspects 21 through 26, wherein the PDCCH order is configured to activate one of the first set of additional ROs associated with the CBRA procedure or the second set of additional ROs associated with the CFRA procedure when the one or more conditions include that the first control information configures the set of common ROs for CBRA in an initial BWP, the first control information configures the set of dedicated ROs for CFRA in the initial BWP, the second control information configures the first set of additional ROs associated with the CBRA, and the second control information configures the second set of additional ROs associated with the CFRA.

Aspect 28: The method of aspect 27, further comprising: outputting a radio resource control message that indicates the one of the first set of additional ROs or the second set of additional ROs to be activated by the PDCCH order, wherein the one or more conditions comprise the indication.

Aspect 29: The method of any of aspects 27 through 28, wherein a preamble associated with the PDCCH order indicates the one of the first set of additional ROs or the second set of additional ROs to be activated by the PDCCH order, the one or more conditions comprise the indication.

Aspect 30: The method of any of aspects 21 through 29, wherein the PDCCH order is not configured to activate the first set of additional ROs associated with the CBRA procedure when the one or more conditions include that the first control information configures the set of common ROs for CBRA in an initial BWP, the first control information configures the set of dedicated ROs for CFRA in an active BWP different from the initial BWP, and the PDCCH order activates the CFRA procedure.

Aspect 31: The method of any of aspects 21 through 30, wherein the PDCCH order is configured to activate the first set of additional ROs associated with the CBRA procedure when the one or more conditions include that the first control information configures the set of common ROs for CBRA in an initial BWP, the first control information configures the set of dedicated ROs for CFRA in an active BWP different from the initial BWP, the second control information configures the first set of additional ROs in the initial BWP, and the PDCCH order activates the CFRA procedure, the method further comprising: switching from the active BWP to the initial BWP in accordance with the activation of the first set of additional ROs.

Aspect 32: A method for wireless communication at a network entity, comprising: outputting first control information that configures a set of common ROs and a set of additional ROs; outputting second control information that triggers a random access procedure, wherein the second control information activates, for the random access procedure, the set of common ROs, the set of additional ROs, or both, and wherein a duration of activation is associated with a type of message that carries the second control information; and monitoring for a random access message via the set of common ROs or the set of additional ROs in accordance with the second control information.

Aspect 33: The method of aspect 32, wherein the duration of the activation includes a first duration when the type of message is a paging DCI message or a second duration when the type of message is a PDCCH order.

Aspect 34: The method of aspect 33, wherein the second duration is based on a timer and the first duration is based on a quantity of ROs.

Aspect 35: The method of any of aspects 33 through 34, wherein the first duration is based on a timer and the second duration is based on a quantity of ROs.

Aspect 36: The method of any of aspects 33 through 35, wherein monitoring for the random access message comprises: monitoring for the random access message during the first duration in accordance with the second control information activating the set of additional ROs.

Aspect 37: The method of any of aspects 33 through 36, wherein monitoring for the random access message comprises: monitoring for the random access message during the second duration in accordance with the second control information being the PDCCH order.

Aspect 38: The method of any of aspects 32 through 37, further comprising: outputting, during the duration of activation, third control information that triggers the random access procedure, wherein the third control information indicates a second activation of the set of common ROs, the set of additional ROs, or both, and wherein the duration activation is extended in accordance with receiving the third control information.

Aspect 39: The method of aspect 38, wherein the extended duration comprises a sum of an elapsed portion of a first duration indicated by the second control information and a second duration indicated by the third control information.

Aspect 40: The method of any of aspects 38 through 39, wherein the extended duration comprises a sum of a first duration indicated by the second control information and a second duration indicated by the third control information.

Aspect 41: A network entity for wireless communication, comprising a processing system that includes processor circuitry and memory circuitry that stores code, the processing system configured to cause the network entity to perform a method of any of aspects 1 through 11.

Aspect 42: A network entity for wireless communication, comprising at least one means for performing a method of any of aspects 1 through 11.

Aspect 43: A non-transitory computer-readable medium storing code for wireless communication, the code comprising instructions executable by one or more processors to perform a method of any of aspects 1 through 11.

Aspect 44: A network entity for wireless communication, comprising a processing system that includes processor circuitry and memory circuitry that stores code, the processing system configured to cause the network entity to perform a method of any of aspects 12 through 20.

Aspect 45: A network entity for wireless communication, comprising at least one means for performing a method of any of aspects 12 through 20.

Aspect 46: A non-transitory computer-readable medium storing code for wireless communication, the code comprising instructions executable by one or more processors to perform a method of any of aspects 12 through 20.

Aspect 47: A network entity for wireless communication, comprising a processing system that includes processor circuitry and memory circuitry that stores code, the processing system configured to cause the network entity to perform a method of any of aspects 21 through 31.

Aspect 48: A network entity for wireless communication, comprising at least one means for performing a method of any of aspects 21 through 31.

Aspect 49: A non-transitory computer-readable medium storing code for wireless communication, the code comprising instructions executable by one or more processors to perform a method of any of aspects 21 through 31.

Aspect 50: A network entity for wireless communication, comprising a processing system that includes processor circuitry and memory circuitry that stores code, the processing system configured to cause the network entity to perform a method of any of aspects 32 through 40.

Aspect 51: A network entity for wireless communication, comprising at least one means for performing a method of any of aspects 32 through 40.

Aspect 52: A non-transitory computer-readable medium storing code for wireless communication, the code comprising instructions executable by one or more processors to perform a method of any of aspects 32 through 40.

The methods described herein describe possible implementations, and the operations and the steps may be rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items). Also, as used herein, the phrase “a set” shall be construed as including the possibility of a set with one member. That is, the phrase “a set” shall be construed in the same manner as “one or more” or “at least one of.”

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
a processing system configured to:
receive first control information that configures a set of common random access channel occasions (ROs) for contention-based random access (CBRA), a set of dedicated ROs for contention free random access (CFRA), or both;
receive second control information that configures a first set of additional ROs associated with the CBRA, a second set of additional ROs associated with the CFRA, or both;
receive a physical downlink control channel (PDCCH) order that activates a CFRA procedure, wherein the PDCCH order is configured to activate the set of dedicated ROs, the first set of additional ROs, the second set of additional ROs, or any combination thereof based on satisfaction of one or more conditions; and
transmit a random access message via the set of dedicated ROs, the first set of additional ROs, or the second set of additional ROs in accordance with the PDCCH order.

2. The network entity of claim 1, wherein the PDCCH order is configured to activate the first set of additional ROs associated with the CBRA procedure when the one or more conditions include that the first control information configures the set of common ROs for CBRA in an initial bandwidth part (BWP), the first control information configures the set of dedicated ROs for CFRA in the initial BWP, and the second control information configures the first set of additional ROs associated with the CBRA.

3. The network entity of claim 1, wherein the PDCCH order is not configured to activate the first set of additional ROs associated with the CBRA procedure when the one or more conditions include that the first control information configures the set of common ROs for CBRA in an initial bandwidth part (BWP), the first control information configures the set of dedicated ROs for CFRA in the initial BWP, and the PDCCH order activates the CFRA procedure.

4. The network entity of claim 1, wherein the PDCCH order is configured to activate the second set of additional ROs associated with the CFRA procedure when the one or more conditions include that the first control information configures the set of common ROs for CBRA in an initial bandwidth part (BWP), the first control information configures the set of dedicated ROs for CFRA in the initial BWP, the second control information configures the second set of additional ROs associated with the CFRA, and the PDCCH order activates the CFRA procedure.

5. The network entity of claim 1, wherein the PDCCH order is configured to activate the second set of additional ROs associated with the CFRA procedure when the one or more conditions include that the first control information configures the set of common ROs for CBRA in an initial bandwidth part (BWP), the first control information configures the set of dedicated ROs for CFRA in an active BWP different from the initial BWP, the second control information configures the second set of additional ROs associated with the CFRA, and the PDCCH order activates the CFRA procedure.

6. The network entity of claim 1, wherein the PDCCH order is configured to activate both of the first set of additional ROs associated with the CBRA procedure and the second set of additional ROs associated with the CFRA procedure when the one or more conditions include that the first control information configures the set of common ROs for CBRA in an initial bandwidth part (BWP), the first control information configures the set of dedicated ROs for CFRA in the initial BWP, the second control information configures the first set of additional ROs associated with the CBRA, and the second control information configures the second set of additional ROs associated with the CFRA.

7. The network entity of claim 1, wherein the PDCCH order is configured to activate one of the first set of additional ROs associated with the CBRA procedure or the second set of additional ROs associated with the CFRA procedure when the one or more conditions include that the first control information configures the set of common ROs for CBRA in an initial bandwidth part (BWP), the first control information configures the set of dedicated ROs for CFRA in the initial BWP, the second control information configures the first set of additional ROs associated with the CBRA, and the second control information configures the second set of additional ROs associated with the CFRA.

8. The network entity of claim 7, wherein the processing system is configured to:
receive a radio resource control message that indicates the one of the first set of additional ROs or the second set of additional ROs to be activated by the PDCCH order, wherein the one or more conditions comprise the indication.

9. The network entity of claim 7, wherein a preamble associated with the PDCCH order indicates the one of the first set of additional ROs or the second set of additional ROs to be activated by the PDCCH order, and wherein the one or more conditions comprise the indication.

10. The network entity of claim 1, wherein the PDCCH order is not configured to activate the first set of additional ROs associated with the CBRA procedure when the one or more conditions include that the first control information configures the set of common ROs for CBRA in an initial bandwidth part (BWP), the first control information configures the set of dedicated ROs for CFRA in an active BWP different from the initial BWP, and the PDCCH order activates the CFRA procedure.

11. The network entity of claim 1, wherein the PDCCH order is configured to activate the first set of additional ROs associated with the CBRA procedure when the one or more conditions include that the first control information configures the set of common ROs for CBRA in an initial bandwidth part (BWP), the first control information configures the set of dedicated ROs for CFRA in an active BWP different from the initial BWP, the second control information configures the first set of additional ROs in the initial BWP, and the PDCCH order activates the CFRA procedure, and wherein the processing system is configured to cause the network entity to:
switch from the active BWP to the initial BWP in accordance with the activation of the first set of additional ROs.

12. A network entity, comprising:
a processing system configured to:
receive first control information that configures a set of common random access channel occasions (ROs) and a set of additional ROs;
receive second control information that triggers a random access procedure, wherein the second control information activates, for the random access procedure, the set of common ROs, the set of additional ROs, or both, and wherein a duration of activation is associated with a type of message that carries the second control information; and
transmit a random access message via the set of common ROs or the set of additional ROs in accordance with the second control information.

13. The network entity of claim 12, wherein the duration of the activation includes a first duration when the type of message is a paging downlink control information (DCI) message or a second duration when the type of message is a physical downlink control channel (PDCCH) order.

14. The network entity of claim 13, wherein the second duration is based on a timer and the first duration is based on a quantity of ROs.

15. The network entity of claim 13, wherein the first duration is based on a timer and the second duration is based on a quantity of ROs.

16. The network entity of claim 13, wherein, to transmit the random access message, the processing system is configured to:
transmit the random access message during the first duration in accordance with the second control information activating the set of additional ROs.

17. The network entity of claim 13, wherein, to transmit the random access message, the processing system is configured to:
transmit the random access message during the second duration in accordance with the second control information being the PDCCH order.

18. The network entity of claim 12, wherein the processing system is configured to:
receive, during the duration of activation, third control information that triggers the random access procedure, wherein the third control information indicates a second activation of the set of common ROs, the set of additional ROs, or both, and wherein the duration activation is extended in accordance with receiving the third control information.

19. The network entity of claim 18, wherein the extended duration comprises a sum of an elapsed portion of a first duration indicated by the second control information and a second duration indicated by the third control information.

20. The network entity of claim 18, wherein the extended duration comprises a sum of a first duration indicated by the second control information and a second duration indicated by the third control information.
